(19) United States
(12) Patent Application Publication
(10) Pub. No.: US 2026/0093439 A1
(43) Pub. Date: Apr. 2, 2026

(54) METHOD FOR DRIVING DISPLAY SYSTEM AT LOW POWER WITH MOBILE INDUSTRY PROCESSOR INTERFACE AND DISPLAY DEVICE USING THE SAME

(71) Applicant: SAPIEN SEMICONDUCTORS INC., Sengnam-si (KR)

(72) Inventors: Do Kyung KIM, Sengnam-si (KR); Dae Young JUNG, Sengnam-si (KR); Jong Gu JEON, Sengnam-si (KR); Hyun Tae JUNG, Sengnam-si (KR); In Young CHO, Sengnam-si (KR)

(73) Assignee: SAPIEN SEMICONDUCTORS INC., Sengnam-si (KR)

(21) Appl. No.: 19/320,205

(22) Filed: Sep. 5, 2025

(30) Foreign Application Priority Data
Sep. 30, 2024 (KR) 10-2024-0132612
Nov. 28, 2024 (KR) 10-2024-0173957
Nov. 28, 2024 (KR) 10-2024-0173972
Nov. 28, 2024 (KR) 10-2024-0173985

(51) Int. Cl. G06F 3/147

(52) U.S. Cl. CPC G06F 3/147

(57) ABSTRACT

Method for driving a display system at low power with a Mobile Industry Processor Interface. The method of a display driver IC includes: (a) upon receiving a t1-st MIPI sync signal and a t1-st video data, (i) synchronizing the t1-st MIPI sync signal with a t1-st display sync signal, (ii) generating a t1-st display data, and (iii) transmitting the t1-st display sync signal and the t1-st display data to a display panel having in-pixel memory, to store the t1-st display data in in-pixel memories and display a t1-st video image; and (b) in response to receiving a low power drive initiating command, in case a (t1+1)-th MIPI sync signal and a (t1+1)-th video data has not been received, transmitting a (t1+1)-th display sync signal to the display panel having in-pixel memory, to display the t1-st video image corresponding to the t1-st display data stored in the in-pixel memories.

### CROSS REFERENCE OF RELATED APPLICATION

This present application claims the benefit of the earlier filing date of Korean provisional patent application No. 10-2024-0132612, filed on Sep. 30, 2024, and Korean non-provisional patent applications No. 10-2024-0173957, No. 10-2024-0173972, and No. 10-2024-0173985, filed on Nov. 28, 2024, the entire contents of which being incorporated herein by reference.

### FIELD OF THE DISCLOSURE

The present disclosure relates to a method for driving a display system including a display panel having in-pixel memory at a lower power with a MIPI (i.e., Mobile Industry Processor Interface), and a display device using the same.

### BACKGROUND OF THE DISCLOSURE

An electronic device may display various texts, images, etc., through a display panel.

A MIPI (i.e., Mobile industry Processor Interface) is a display standard of a physical layer for communication between a processor in a portable electronic device such as a smartphone, a tablet PC, a smart watch, etc. and peripherals.

MIPI DSI (i.e., Display Serial Interface) is a display standard that connects an AP (i.e., Application Processor) and a display. MIPI DSI includes a video mode and a command mode.

In the video mode, a host may transmit video data to a display driver IC in real time and the display driver IC may allow a corresponding video to be displayed through the display panel by using the video data transmitted in real time from the host.

Herein, in the video mode, even if an image of the video to be displayed is a still image, the host has to repeatedly transmit the video data corresponding to the still image to the display driver IC, resulting in an increase in a burden on the host. Therefore, there is a problem of increased power consumption of the host.

Further, in the command mode, the display driver IC may transmit an interrupt signal, for example, a TE (i.e., Tearing Effect) signal to the host; and the host may send the video data to the display driver IC in response to receiving the TE signal.

Herein, in the command mode, when the still image is to be displayed on the display panel, the display driver IC may periodically scan the video data, i.e. the still image, stored in one or more frame memories of the display driver IC and transmit the scanned still image to the display panel. This process is called panel self-refresh.

However, the command mode has a disadvantage of requiring additional frame memories, which may affect a size and a price of the display driver IC.

Meanwhile, in conventional display systems, as explained above, the video data has to be repeatedly refreshed in order to display the still image, whereas a display panel having in-pixel memory can maintain the video data after displaying it without having to refresh it since each of pixels in the display panel having in-pixel memory has of its own corresponding memory. For reference, the display panel having in-pixel memory is described in detail in Korean Patent Registration No. 10-1942466 of the applicant of the present disclosure, therefore, a description thereof is omitted.

However, even in the display system that uses the display panel having in-pixel memory, there is a problem of the host having to repeatedly transmit the video data to the display driver IC in the video mode, which results in an increase in a work burden and a power consumption of the host. In addition, even when the display system is operating in the command mode, there is a disadvantage of requiring the frame memories to store the video data transmitted from the host, since a size of the video data to be transmitted from the host cannot be predicted.

### SUMMARY OF THE DISCLOSURE

It is an object of the present disclosure to solve all the aforementioned problems of conventional arts.

It is another object of the present disclosure to drive a display system including a display panel having in-pixel memory at low power with a MIPI (i.e., Mobile Industry Processor Interface).

It is still another object of the present disclosure to minimize the number of transmissions of video data from a host with the MIPI thereby reducing a burden of the host and minimizing a power consumption of the host.

It is still yet another object of the present disclosure to minimize the number of refreshing the video data of a display driver IC and minimize a power consumption of the display driver IC.

It is still yet another object of the present disclosure to allow the display driver IC to display a still image by using data stored in the in-pixel memories according to a MIPI sync signal while the host transmits only the MIPI sync signal, thereby minimizing power consumptions of the host and the display driver IC.

It is still yet another object of the present disclosure to display the still image by using the data stored in the in-pixel memories while disabling the MIPI, thereby minimizing the power consumptions of the host and the display driver IC.

It is still yet another object of the present disclosure to display the still image by using the data stored in the in-pixel memories while being switched to a command mode, thereby minimizing the power consumptions of the host and the display driver IC.

In order to accomplish objects above, representative structures of the present disclosure are described as follows:

In accordance to one aspect of the present disclosure there is provided a method for driving a display system at low power with a MIPI (Mobile Industry Processor Interface), including steps of: (a) upon receiving, from a host, a t1-st MIPI sync signal corresponding to a t1-st frame and a t1-st video data corresponding to the t1-st frame, wherein the t1-st video data is in sync with the t1-st MIPI sync signal, a display driver IC (i) synchronizing the t1-st MIPI sync signal with a t1-st display sync signal, (ii) generating a t1-st display data corresponding to the t1-st frame by referring to the t1-st video data, and (iii) transmitting the t1-st display sync signal and the t1-st display data to a display panel having in-pixel memory, to thereby instruct the display panel having in-pixel memory to store the t1-st display data in in-pixel memories and display a t1-st video image corresponding to the t1-st display data stored in the in-pixel memories according to the t1-st display sync signal; and (b) in response to receiving a (t1+1)-th MIPI sync signal only corresponding to a (t1+1)-th frame, the display driver IC synchronizing the (t1+1)-th MIPI sync signal with a (t1+1)-th display sync signal, and transmitting the (t1+1)-th display sync signal to the display panel having in-pixel memory, to thereby instruct the display panel having in-pixel memory to display the t1-st video image corresponding to the t1-st display data stored in the in-pixel memories according to the (t1+1)-th display sync signal.

As one example, (c) upon receiving, from the host, a t2-nd MIPI sync signal corresponding to a t2-nd frame and a t2-nd video data corresponding to the t2-nd frame, wherein the t2-nd frame is apart from the (t1+1)-th frame by at least one frame, and wherein the t2-nd video data is in sync with the t2-nd MIPI sync signal, the display driver IC synchronizing the t2-nd MIPI sync signal with a t2-nd display sync signal, generating a t2-nd display data corresponding to the t2-nd frame from the t2-nd video data, and transmitting the t2-nd display sync signal and the t2-nd display data to the display panel having in-pixel memory, to thereby instruct the display panel having in-pixel memory to update the t1-st display data stored in the in-pixel memories to the t2-nd display data, and display a t2-nd video image corresponding to the t2-nd display data updated in the in-pixel memories according to the t2-nd display sync signal.

As one example, at the step of (c), the display driver IC (i) receives, from the host, a t2-nd MIPI vertical sync signal, and sequentially receives, from the host, a pair of a (t2_1)-st MIPI horizontal sync signal and a (t2_1)-st horizontal video data to a pair of a (t2_p)-th MIPI horizontal sync signal and a (t2_p)-th horizontal video data, each corresponding to each of p display lines in the display panel having in-pixel memory, wherein p is an integer greater than or equal to 1, and wherein the (t2_1)-st horizontal video data is in sync with the (t2_1)-st MIPI horizontal sync signal and the (t2_p)-th horizontal video data is in sync with the (t2_p)-th MIPI horizontal sync signal, and (ii) at a time of receiving a (t2_k)-th MIPI horizontal sync signal and a (t2_k)-th horizontal video data from the host, wherein k is an integer greater than or equal to 1 and less than or equal to p, (ii-1) synchronizes the (t2_k)-th MIPI horizontal sync signal with a (t2_k)-th display horizontal sync signal, (ii-2) generates a (t2_k)-th horizontal display data by referring to the (t2_k)-th horizontal video data, and (ii-3) transmits the (t2_k)-th horizontal display sync signal and the (t2_k)-th horizontal display data to the display panel having in-pixel memory, to thereby instruct the display panel having in-pixel memory to update the (t2_k)-th horizontal display data in the in-pixel memories, which are included in the k-th display line.

As one example, at the step of (c), the display driver IC transmits the (t2_k)-th horizontal display data in parallel to the display panel having in-pixel memory by using a shift register or a line buffer, to thereby instruct the display panel having in-pixel memory to simultaneously store the (t2_k)-th horizontal display data in the in-pixel memories which are included within the k-th display line.

As one example, at the step of (c), the display driver IC generates the t2-nd display data as n bit data, wherein n is an integer greater than or equal to 2, to thereby (i) update each of the in-pixel memories to the t2-nd display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

As one example, at the step of (a), the display driver IC receives, from the host, a t1-st MIPI vertical sync signal, and sequentially receives, from the host, a pair of a (t1_1)-st MIPI horizontal sync signal and a (t1_1)-st horizontal video data to a pair of a (t1_p)-th MIPI horizontal sync signal and a (t1_p)-th horizontal video data, each of which corresponds to each of p display lines in the display panel having in-pixel memory, wherein the (t1_1)-st horizontal video data is in sync with the (t1_1)-st MIPI horizontal sync signal and the (t1_p)-th horizontal video data is in sync with the (t1_p)-th MIPI horizontal sync signal, and (ii) at a time of receiving a (t1_k)-th MIPI horizontal sync signal and a (t1_k)-th horizontal video data from the host, wherein k is an integer greater than or equal to 1 and less than or equal to p, (ii-1) synchronizes the (t1_k)-th MIPI horizontal sync signal with a (t1_k)-th horizontal display sync signal, (ii-2) generates a (t1_k)-th horizontal display data by referring to the (t1_k)-th horizontal video data, and (ii-3) transmits the (t1_k)-th horizontal display sync signal and the (t1_k)-th horizontal display data to the display panel having in-pixel memory, to thereby instruct the display panel having in-pixel memory to update the in-pixel memories, which are included within the k-th display line, to the (t1_k)-th horizontal display data.

As one example, at the step of (a), the display driver IC transmits the (t1_k)-th horizontal display data in parallel to the display panel having in-pixel memory by using a shift register or a line buffer, to thereby instruct the display panel having in-pixel memory to simultaneously store the (t1_k)-th horizontal display data in the in-pixel memories, which are included within the k-th display line.

As one example, at the step of (a), the display driver IC generates the t1-st display data as an n bit data, wherein n is an integer greater than or equal to 2, to thereby (i) update each of the in-pixel memories to the t1-st display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

In accordance with another aspect of the present disclosure, there is provided a display device for driving a display system at low power with a MIPI (Mobile Industry Processor Interface), including: a display driver IC; and a display panel having in-pixel memory; (I) wherein, upon receiving, from a host, a t1-st MIPI sync signal corresponding to a t1-st frame and a t1-st video data corresponding to the t1-st frame, the t1-st video data being in sync with the t1-st MIPI sync signal, the display driver IC (i) synchronizes the t1-st MIPI sync signal with a t1-st display sync signal, (ii) generates a t1-st display data corresponding to the t1-st frame by referring to the t1-st video data, and (iii) transmits the t1-st display sync signal and the t1-st display data to the display panel having in-pixel memory, to thereby instruct the display panel having in-pixel memory to store the t1-st display data in in-pixel memories and display a t1-st video image corresponding to the t1-st display data stored in the in-pixel memories according to the t1-st display sync signal; and (II) wherein, on condition that the display driver IC has received a (t1+1)-th MIPI sync signal only corresponding to a (t1+1)-th frame, the display driver IC synchronizes the (t1+1)-th MIPI sync signal with a (t1+1)-th display sync signal, and transmits the (t1+1)-th display sync signal to the display panel having in-pixel memory, to thereby instruct the display panel having in-pixel memory to display the t1-st video image corresponding to the t1-st display data stored in the in-pixel memories according to the (t1+1)-th display sync signal.

As one example, (III) upon receiving, from the host, a t2-nd MIPI sync signal corresponding to a t2-nd frame and t2-nd video data corresponding to the t2-nd frame, the t2-nd video data being in sync with the t2-nd MIPI sync signal and the t2-nd frame being apart from the (t1+1)-th frame by at least one frame, the display driver IC synchronizes the t2-nd MIPI sync signal with a t2-nd display sync signal, generates t2-nd display data corresponding to the t2-nd frame from the t2-nd video data, and transmits the t2-nd display sync signal and the t2-nd display data to the display panel having in-pixel memory, to thereby instruct the display panel having in-pixel memory to update the t1-st display data stored in the in-pixel memories to the t2-nd display data, and display a t2-nd video image corresponding to the t2-nd display data updated in the in-pixel memories according to the t2-nd display sync signal.

As one example, at the (III), the display driver IC (i) receives, from the host, a t2-nd MIPI vertical sync signal, and sequentially receives, from the host, a pair of a (t2_1)-st MIPI horizontal sync signal and a (t2_1)-st horizontal video data to a pair of a (t2_p)-th MIPI horizontal sync signal and a (t2_p)-th horizontal video data, each corresponding to each of p display lines in the display panel having in-pixel memory, wherein p is an integer greater than or equal to 1, and wherein the (t2_1)-st horizontal video data is in sync with the (t2_1)-st MIPI horizontal sync signal and the (t2_p)-th horizontal video data is in sync with the (t2_p)-th MIPI horizontal sync signal, and (ii) at a time of receiving a (t2_k)-th MIPI horizontal sync signal and a (t2_k)-th horizontal video data from the host, wherein k is an integer greater than or equal to 1 and less than or equal to p, (ii-1) synchronizes the (t2_k)-th MIPI horizontal sync signal with a (t2_k)-th display horizontal sync signal, (ii-2) generates a (t2_k)-th horizontal display data by referring to the (t2_k)-th horizontal video data, and (ii-3) transmits the (t2_k)-th horizontal display sync signal and the (t2_k)-th horizontal display data to the display panel having in-pixel memory, to thereby instruct the display panel having in-pixel memory to update the (t2_k)-th horizontal display data in the in-pixel memories, which are included in the k-th display line.

As one example, at the (III), the display driver IC transmits the (t2_k)-th horizontal display data in parallel to the display panel having in-pixel memory by using a shift register or a line buffer, to thereby instruct the display panel having in-pixel memory to simultaneously store the (t2_k)-th horizontal display data in the in-pixel memories which are included within the k-th display line.

As one example, at the (III), the display driver IC generates the t2-nd display data as n bit data, wherein n is an integer greater than or equal to 2, to thereby (i) update each of the in-pixel memories to the t2-nd display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

As one example, at the (I), the display driver IC receives, from the host, a t1-st MIPI vertical sync signal, and sequentially receives, from the host, a pair of a (t1_1)-st MIPI horizontal sync signal and a (t1_1)-st horizontal video data to a pair of a (t1_p)-th MIPI horizontal sync signal and a (t1_p)-th horizontal video data, each of which corresponds to each of p display lines in the display panel having in-pixel memory, wherein the (t1_1)-st horizontal video data is in sync with the (t1_1)-st MIPI horizontal sync signal and the (t1_p)-th horizontal video data is in sync with the (t1_p)-th MIPI horizontal sync signal, and (ii) at a time of receiving a (t1_k)-th MIPI horizontal sync signal and a (t1_k)-th horizontal video data from the host, wherein k is an integer greater than or equal to 1 and less than or equal to p, (ii-1) synchronizes the (t1_k)-th MIPI horizontal sync signal with a (t1_k)-th horizontal display sync signal, (ii-2) generates a (t1_k)-th horizontal display data by referring to the (t1_k)-th horizontal video data, and (ii-3) transmits the (t1_k)-th horizontal display sync signal and the (t1_k)-th horizontal display data to the display panel having in-pixel memory, to thereby instruct the display panel having in-pixel memory to update the in-pixel memories, which are included within the k-th display line, to the (t1_k)-th horizontal display data.

As one example, at the (I), the display driver IC transmits the (t1_k)-th horizontal display data in parallel to the display panel having in-pixel memory by using a shift register or a line buffer, to thereby instruct the display panel having in-pixel memory to simultaneously store the (t1_k)-th horizontal display data in the in-pixel memories, which are included within the k-th display line.

As one example, at the (I), the display driver IC generates the t1-st display data as an n bit data, wherein n is an integer greater than or equal to 2, to thereby (i) update each of the in-pixel memories to the t1-st display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

In accordance to still yet another aspect of the present disclosure, there is provided a method for driving a display system at low power with a MIPI (Mobile Industry Processor Interface), including steps of: (a) upon receiving, from a host, a t1-st MIPI sync signal corresponding to a t1-st frame and a t1-st video data corresponding to the t1-st frame, wherein the t1-st video data is in sync with the t1-st MIPI sync signal, a display driver IC (i) synchronizing the t1-st MIPI sync signal with a t1-st display sync signal, (ii) generating a t1-st display data corresponding to the t1-st frame by referring to the t1-st video data, and (iii) transmitting the t1-st display sync signal and the t1-st display data to a display panel having in-pixel memory, to thereby instruct the display panel having in-pixel memory to store the t1-st display data in in-pixel memories and display a t1-st video image corresponding to the t1-st display data stored in the in-pixel memories according to the t1-st display sync signal; and (b) on condition that the display driver IC has received a low power drive initiating command for a t1-st porch region corresponding to the t1-st MIPI sync signal from the host, in case the display driver IC has not received a (t1+1)-th MIPI sync signal corresponding to a (t1+1)-th frame and a (t1+1)-th video data corresponding to the (t1+1)-th frame, wherein the (t1+1)-th video data is in sync with the (t1+1)-th MIPI sync signal, the display driver IC transmitting a (t1+1)-th display sync signal corresponding to the t1-st display sync signal to the display panel having in-pixel memory, to thereby instruct the display panel having in-pixel memory to display the t1-st video image corresponding to the t1-st display data stored in the in-pixel memories according to the (t1+1)-th display sync signal.

As one example, the method further includes a step of: (c) upon receiving, from the host, a t2-nd MIPI sync signal corresponding to a t2-nd frame and a t2-nd video data corresponding to the t2-nd frame, wherein the t2-nd video data is in sync with the t2-nd MIPI sync signal and wherein the t2-nd frame is apart from the (t1+1)-th frame by at least one frame, and upon receiving, from the host, a low power drive terminating command for a t2-nd porch region corresponding to the t2-nd MIPI sync signal, while the display driver IC is displaying the t1-st video image through the display panel having in-pixel memory, the display driver IC (i) stopping the t1 video image to be displayed through the display panel having in-pixel memory, and, (ii) in response to receiving, from the host, a (t2+1)-th MIPI sync signal corresponding to a (t2+1)-th frame and a (t2+1)-th video data corresponding to the (t2+1)-th frame, wherein the (t2+1)-th video data is in sync with the (t2+1)-th MIPI sync signal, (ii-1) synchronizing the (t2+1)-th MIPI sync signal with a (t2+1)-th display sync signal, (ii-2) generating a (t2+1)-th display data corresponding to the (t2+1)-th frame by referring to (t2+1)-th video data, and (ii-3) transmitting the (t2+1)-th display sync signal and the (t2+1)-th display data to the display panel having in-pixel memory, to thereby instruct the display panel having in-pixel memory to (ii-3-a) update the t1-st display data, stored in the in-pixel memories, to the (t2+1)-th display data and (ii-3-b) display a (t2+1)-th video image corresponding the (t2+1)-th display data having been updated in the in-pixel memories according to the (t2+1)-th display sync signal.

As one example, at the step of (c), the display driver IC (i) receives, from the host, a (t2+1)-th MIPI vertical sync signal, and sequentially receives, from the host, a pair of a ((t2+1)_1)-st MIPI horizontal sync signal and a ((t2+1)_1)-st horizontal video data to a pair of a ((t2+1)_p)-th MIPI horizontal sync signal and a ((t2+1)_p)-th horizontal video data, each of which corresponds to each of p display lines in the display panel having in-pixel memory, wherein the ((t2+1)_1)-st horizontal video data is in sync with the ((t2+1)_1)-st MIPI horizontal sync signal and the ((t2+1)_p)-th horizontal video data is in sync with the ((t2+1)_p)-th MIPI horizontal sync signal, and (ii) at a time of receiving a ((t2+1)_k)-th MIPI horizontal sync signal and a ((t2+1)_k)-th horizontal video data from the host, wherein k is an integer greater than or equal to 1 and less than or equal to p, (ii-1) synchronizes the ((t2+1)_k)-th MIPI horizontal sync signal with a ((t2+1)_k)-th horizontal display sync signal, (ii-2) generates a ((t2+1)_k)-th horizontal display data by referring to the ((t2+1)_k)-th horizontal video data, and (ii-3) transmits the ((t2+1)_k)-th horizontal display sync signal and the ((t2+1)_k)-th horizontal display data to the display panel having in-pixel memory, to thereby instruct the display panel having in-pixel memory to update the ((t2+1)_k)-th horizontal display data in the in-pixel memories, which are included within the k-th display line.

As one example, at the step of (c), the display driver IC transmits the ((t2+1)_k)-th horizontal display data in parallel to the display panel having in-pixel memory by using a shift register or a line buffer, to thereby instruct the display panel having in-pixel memory to simultaneously store the ((t2+1)_k)-th horizontal display data in the in-pixel memories, which are included within the k-th display line.

As one example, at the step of (c), the display driver IC generates the (t2+1)-th display data as n bit data, wherein n is an integer greater than or equal to 2, to thereby (i) update each of the in-pixel memories to the (t2+1)-th display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

As one example, at the step of (c), the display driver IC receives, from the host, the t2-nd MIPI sync signal and the t2-nd video data, which are identical to the t1-st MIPI sync signal and the t1-st video data.

As one example, at the step of (a), the display driver IC receives, from the host, a t1-st MIPI vertical sync signal, and sequentially receives, from the host, a pair of a (t1_1)-st MIPI horizontal sync signal and a (t1_1)-st horizontal video data to a pair of a (t1_p)-th MIPI horizontal sync signal and a (t1_p)-th horizontal video data, each of which corresponds to each of p display lines in the display panel having in-pixel memory, wherein the (t1_1)-st horizontal video data is in sync with the (t1_1)-st MIPI horizontal sync signal and the (t1_p)-th horizontal video data is in sync with the (t1_p)-th MIPI horizontal sync signal, and (ii) at a time of receiving a (t1_k)-th MIPI horizontal sync signal and a (t1_k)-th horizontal video data from the host, wherein k is an integer greater than or equal to 1 and less than or equal to p, (ii-1) synchronizes the (t1_k)-th MIPI horizontal sync signal with a (t1_k)-th horizontal display sync signal, (ii-2) generates a (t1_k)-th horizontal display data by referring to the (t1_k)-th horizontal video data, and (ii-3) transmits the (t1_k)-th horizontal display sync signal and the (t1_k)-th horizontal display data to the display panel having in-pixel memory, to thereby instruct the display panel having in-pixel memory to update the in-pixel memories, which are included within the k-th display line to the (t1_k)-th horizontal display data.

As one example, at the step of (a), the display driver IC transmits the (t1_k)-th horizontal display data in parallel to the display panel having in-pixel memory by using a shift register or a line buffer, to thereby instruct the display panel having in-pixel memory to simultaneously store the (t1_k)-th horizontal display data in the in-pixel memories, which are included within the k-th display line.

As one example, at the step of (a), the display driver IC generates the t1-st display data as an n bit data, wherein n is an integer greater than or equal to 2, to thereby (i) update each of the in-pixel memories to the t1-st display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

In accordance with still yet another aspect of the present disclosure, there is provided a display device for driving a display system at low power with a MIPI (Mobile Industry Processor Interface), including: a display driver IC; and a display panel having in-pixel memory; (I) wherein, upon receiving, from a host, a t1-st MIPI sync signal corresponding to a t1-st frame and a t1-st video data corresponding to the t1-st frame, the t1-st video data being in sync with the t1-st MIPI sync signal, the display driver IC (i) synchronizes the t1-st MIPI sync signal with a t1-st display sync signal, (ii) generates a t1-st display data corresponding to the t1-st frame by referring to the t1-st video data, and (iii) transmits the t1-st display sync signal and the t1-st display data to the display panel having in-pixel memory, to thereby instruct the display panel having in-pixel memory to store the t1-st display data in in-pixel memories and display a t1-st video image corresponding to the t1-st display data stored in the in-pixel memories according to the t1-st display sync signal; and (II) wherein, on condition that the display driver IC has received a low power drive initiating command for a t1-st porch region corresponding to the t1-st MIPI sync signal from the host, in case the display driver IC has not received a (t1+1)-th MIPI sync signal corresponding to a (t1+1)-th frame and a (t1+1)-th video data corresponding to the (t1+1)-th frame, the (t1+1)-th video data being in sync with the (t1+1)-th MIPI sync signal, the display driver IC transmits a (t1+1)-th display sync signal corresponding to the t1-st display sync signal to the display panel having in-pixel memory, to thereby instruct the display panel having in-pixel memory to display the t1-st video image corresponding to the t1-st display data stored in the in-pixel memories according to the (t1+1)-th display sync signal.

As one example, (III) upon receiving, from the host, a t2-nd MIPI sync signal corresponding to a t2-nd frame and a t2-nd video data corresponding to the t2-nd frame, the t2-nd video data being in sync with the t2-nd MIPI sync signal and the t2-nd frame being apart from the (t1+1)-th frame by at least one frame, and upon receiving, from the host, a low power drive terminating command for a t2-nd porch region corresponding to the t2-nd MIPI sync signal, while the display driver IC is displaying the t1-st video image through the display panel having in-pixel memory, the display driver IC (i) stops the t1 video image to be displayed through the display panel having in-pixel memory, and, (ii) in response to receiving, from the host, a (t2+1)-th MIPI sync signal corresponding to a (t2+1)-th frame and a (t2+1)-th video data corresponding to the (t2+1)-th frame, the (t2+1)-th video data being in sync with the (t2+1)-th MIPI sync signal, (ii-1) synchronizes the (t2+1)-th MIPI sync signal with a (t2+1)-th display sync signal, (ii-2) generates a (t2+1)-th display data corresponding to the (t2+1)-th frame by referring to (t2+1)-th video data, and (ii-3) transmits the (t2+1)-th display sync signal and the (t2+1)-th display data to the display panel having in-pixel memory, to thereby instruct the display panel having in-pixel memory to (ii-3-a) update the t1-st display data, stored in the in-pixel memories, to the (t2+1)-th display data and (ii-3-b) display a (t2+1)-th video image corresponding the (t2+1)-th display data having been updated in the in-pixel memories according to the (t2+1)-th display sync signal.

As one example, at the (III), the display driver IC (i) receives, from the host, a (t2+1)-th MIPI vertical sync signal, and sequentially receives, from the host, a pair of a ((t2+1)_1)-st MIPI horizontal sync signal and a ((t2+1)_1)-st horizontal video data to a pair of a ((t2+1)_p)-th MIPI horizontal sync signal and a ((t2+1)_p)-th horizontal video data, each of which corresponds to each of p display lines in the display panel having in-pixel memory, wherein the ((t2+1)_1)-st horizontal video data is in sync with the ((t2+1)_1)-st MIPI horizontal sync signal and the ((t2+1)_p)-th horizontal video data is in sync with the ((t2+1)_p)-th MIPI horizontal sync signal, and (ii) at a time of receiving a ((t2+1)_k)-th MIPI horizontal sync signal and a ((t2+1)_k)-th horizontal video data from the host, k being an integer greater than or equal to 1 and less than or equal to p, (ii-1) synchronizes the ((t2+1)_k)-th MIPI horizontal sync signal with a ((t2+1)_k)-th horizontal display sync signal, (ii-2) generates a ((t2+1)_k)-th horizontal display data by referring to the ((t2+1)_k)-th horizontal video data, and (ii-3) transmits the ((t2+1)_k)-th horizontal display sync signal and the ((t2+1)_k)-th horizontal display data to the display panel having in-pixel memory, to thereby instruct the display panel having in-pixel memory to update the ((t2+1)_k)-th horizontal display data in the in-pixel memories, which are included within the k-th display line.

As one example, at the (III), the display driver IC transmits the ((t2+1)_k)-th horizontal display data in parallel to the display panel having in-pixel memory by using a shift register or a line buffer, to thereby instruct the display panel having in-pixel memory to simultaneously store the ((t2+1)_k)-th horizontal display data in the in-pixel memories which are included within the k-th display line.

As one example, at the (III), the display driver IC generates the (t2+1)-th display data as n bit data, wherein n is an integer greater than or equal to 2, to thereby (i) update each of the in-pixel memories to the (t2+1)-th display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

As one example, at the (III), the display driver IC receives, from the host, the t2-nd MIPI sync signal and the t2-nd video data, which are identical to the t1-st MIPI sync signal and the t1-st video data.

As one example, at the (I), the display driver IC receives, from the host, a t1-st MIPI vertical sync signal, and sequentially receives, from the host, a pair of a (t1_1)-st MIPI horizontal sync signal and a (t1_1)-st horizontal video data to a pair of a (t1_p)-th MIPI horizontal sync signal and a (t1_p)-th horizontal video data, each of which corresponds to each of p display lines in the display panel having in-pixel memory, wherein the (t1_1)-st horizontal video data is in sync with the (t1_1)-st MIPI horizontal sync signal and the (t1_p)-th horizontal video data is in sync with the (t1_p)-th MIPI horizontal sync signal, and (ii) at a time of receiving a (t1_k)-th MIPI horizontal sync signal and a (t1_k)-th horizontal video data from the host, wherein k is an integer greater than or equal to 1 and less than or equal to p, (ii-1) synchronizes the (t1_k)-th MIPI horizontal sync signal with a (t1_k)-th horizontal display sync signal, (ii-2) generates a (t1_k)-th horizontal display data by referring to the (t1_k)-th horizontal video data, and (ii-3) transmits the (t1_k)-th horizontal display sync signal and the (t1_k)-th horizontal display data to the display panel having in-pixel memory, to thereby instruct the display panel having in-pixel memory to update the in-pixel memories, which are included within the k-th display line to the (t1_k)-th horizontal display data.

As one example, at the (I), the display driver IC transmits the (t1_k)-th horizontal display data in parallel to the display panel having in-pixel memory by using a shift register or a line buffer, to thereby instruct the display panel having in-pixel memory to simultaneously store the (t1_k)-th horizontal display data in the in-pixel memories which are included within the k-th display line.

As one example, at the (I), the display driver IC generates the t1-st display data as an n bit data, wherein n is an integer greater than or equal to 2, to thereby (i) update each of the in-pixel memories to the t1-st display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

In accordance to still yet another aspect of the present disclosure, there is provided a method for driving a display system at low power with a MIPI (Mobile Industry Processor Interface), including steps of: (a) upon receiving, from a host, a t1-st MIPI sync signal corresponding to a t1-st frame and a t1-st video data corresponding to the t1-st frame, wherein the t1-st video data is in sync with the t1-st MIPI sync signal, a display driver IC (i) synchronizing the t1-st MIPI sync signal with a t1-st display sync signal, (ii) generating a t1-st display data corresponding to the t1-st frame by referring to the t1-st video data, and (iii) transmitting the t1-st display sync signal and the t1-st display data to a display panel having in-pixel memory, to thereby instruct the display panel having in-pixel memory to store the t1-st display data in in-pixel memories and display a t1-st video image corresponding to the t1-st display data stored in the in-pixel memories according to the t1-st display sync signal; and (b) upon receiving, from the host, a command mode switching signal, the display driver IC generating a t11-th display sync signal corresponding to a pre-set condition without transmitting an interrupt signal to the host, and transmitting the t11-th display sync signal to the display panel having in-pixel memory, to thereby instruct the display panel having in-pixel memory to display the t1-st video image corresponding to the t1-st display data stored in the in-pixel memories according to the t11-th display sync signal. As one example, (c) upon receiving, from the host, a video mode switching signal while the display driver IC is displaying the t1-st video image through the display panel having in-pixel memory, and subsequently, upon receiving a t2-nd MIPI sync signal corresponding to a t2-nd frame and a t2-nd video data corresponding to the t2-nd frame, wherein the t2-nd frame is apart from the (t1+1)-th frame by at least one frame, and wherein the t2-nd video data is in sync with the t2-nd MIPI sync signal, (i) the display driver IC (i-1) blocking the t1-st video image from being displayed on the display panel having in-pixel memory, (i-2) synchronizing the t2-nd MIPI sync signal with a t2-nd display sync signal, and (i-3) generating a t2-nd display data corresponding to the t2-nd frame from the t2-nd video data, and (ii) the display driver IC transmitting the t2-nd display sync signal and the t2-nd display data to the display panel having in-pixel memory, to thereby instruct the display panel having in-pixel memory to update the t1-st display data stored in the in-pixel memories to the t2-nd display data, and display a t2-nd video image corresponding to the t2-nd display data updated in the in-pixel memories according to the t2-nd display sync signal.

As one example, at the step of (c), the display driver IC (i) receives, from the host, a t2-nd MIPI vertical sync signal, and sequentially receives, from the host, a pair of a (t2_1)-st MIPI horizontal sync signal and a (t2_1)-st horizontal video data to a pair of a (t2_p)-th MIPI horizontal sync signal and a (t2_p)-th horizontal video data, each corresponding to each of p display lines in the display panel having in-pixel memory, wherein p is an integer greater than or equal to 1, and wherein the (t2_1)-st horizontal video data is in sync with the (t2_1)-st MIPI horizontal sync signal and the (t2_p)-th horizontal video data is in sync with the (t2_p)-th MIPI horizontal sync signal, and (ii) at a time of receiving a (t2_k)-th MIPI horizontal sync signal and a (t2_k)-th horizontal video data from the host, wherein k is an integer greater than or equal to 1 and less than or equal to p, (ii-1) synchronizes the (t2_k)-th MIPI horizontal sync signal with a (t2_k)-th display horizontal sync signal, (ii-2) generates a (t2_k)-th horizontal display data by referring to the (t2_k)-th horizontal video data, and (ii-3) transmits the (t2_k)-th horizontal display sync signal and the (t2_k)-th horizontal display data to the display panel having in-pixel memory, to thereby instruct the display panel having in-pixel memory to update the (t2_k)-th horizontal display data in the in-pixel memories, which are included in the k-th display line.

As one example, at the step of (c), the display driver IC transmits the (t2_k)-th horizontal display data in parallel to the display panel having in-pixel memory by using a shift register or a line buffer, to thereby instruct the display panel having in-pixel memory to simultaneously store the (t2_k)-th horizontal display data in the in-pixel memories, which are included within the k-th display line.

As one example, at the step of (c), the display driver IC generates the t2-nd display data as n bit data, wherein n is an integer greater than or equal to 2, to thereby (i) update each of the in-pixel memories to the t2-nd display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

As one example, at the step of (a), the display driver IC receives, from the host, a t1-st MIPI vertical sync signal, and sequentially receives, from the host, a pair of a (t1_1)-st MIPI horizontal sync signal and a (t1_1)-st horizontal video data to a pair of a (t1_p)-th MIPI horizontal sync signal and a (t1_p)-th horizontal video data, each of which corresponds to each of p display lines in the display panel having in-pixel memory, wherein the (t1_1)-st horizontal video data is in sync with the (t1_1)-st MIPI horizontal sync signal and the (t1_p)-th horizontal video data is in sync with the (t1_p)-th MIPI horizontal sync signal, and (ii) at a time of receiving a (t1_k)-th MIPI horizontal sync signal and a (t1_k)-th horizontal video data from the host, wherein k is an integer greater than or equal to 1 and less than or equal to p, (ii-1) synchronizes the (t1_k)-th MIPI horizontal sync signal with a (t1_k)-th horizontal display sync signal, (ii-2) generates a (t1_k)-th horizontal display data by referring to the (t1_k)-th horizontal video data, and (ii-3) transmits the (t1_k)-th horizontal display sync signal and the (t1_k)-th horizontal display data to the display panel having in-pixel memory, to thereby instruct the display panel having in-pixel memory to update the in-pixel memories, which are included within the k-th display line, to the (t1_k)-th horizontal display data.

As one example, at the step of (a), the display driver IC transmits the (t1_k)-th horizontal display data in parallel to the display panel having in-pixel memory by using a shift register or a line buffer, to thereby instruct the display panel having in-pixel memory to simultaneously store the (t1_k)-th horizontal display data in the in-pixel memories, which are included within the k-th display line.

As one example, at the step of (a), the display driver IC generates the t1-st display data as an n bit data, wherein n is an integer greater than or equal to 2, to thereby (i) update each of the in-pixel memories to the t1-st display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

As one example, at the step of (b), the display driver IC, when generating the t11-th display sync signal corresponding to the pre-set condition, generates the t11-th display sync signal to have a frequency that is different from a frequency of the t1-st MIPI sync signal.

In accordance with still another aspect of the present disclosure, there is provided a display device for driving a display system at low power with a MIPI (Mobile Industry Processor Interface), including: a display driver IC; and a display panel having in-pixel memory; (I) wherein, upon receiving, from a host, a t1-st MIPI sync signal corresponding to a t1-st frame and a t1-st video data corresponding to the t1-st frame, wherein the t1-st video data is in sync with the t1-st MIPI sync signal, a display driver IC (i) synchronizes the t1-st MIPI sync signal with a t1-st display sync signal, (ii) generates a t1-st display data corresponding to the t1-st frame by referring to the t1-st video data, and (iii) transmits the t1-st display sync signal and the t1-st display data to a display panel having in-pixel memory, to thereby instruct the display panel having in-pixel memory to store the t1-st display data in in-pixel memories and display a t1-st video image corresponding to the t1-st display data stored in the in-pixel memories according to the t1-st display sync signal; and (II) wherein, upon receiving, from the host, a command mode switching signal, the display driver IC generates a t11-th display sync signal corresponding to a pre-set condition without transmitting an interrupt signal to the host, and transmits the t11-th display sync signal to the display panel having in-pixel memory, to thereby instruct the display panel having in-pixel memory to display the t1-st video image corresponding to the t1-st display data stored in the in-pixel memories according to the t11-th display sync signal.

As one example, (III) upon receiving, from the host, a video mode switching signal while the display driver IC is displaying the t1-st video image through the display panel having in-pixel memory, and subsequently, upon receiving a t2-nd MIPI sync signal corresponding to a t2-nd frame and a t2-nd video data corresponding to the t2-nd frame, wherein the t2-nd frame is apart from the (t1+1)-th frame by at least one frame, and wherein the t2-nd video data is in sync with the t2-nd MIPI sync signal, (i) the display driver IC (i-1) blocks the t1-st video image from being displayed on the display panel having in-pixel memory, (i-2) synchronizes the t2-nd MIPI sync signal with a t2-nd display sync signal, and (i-3) generates a t2-nd display data corresponding to the t2-nd frame from the t2-nd video data, and (ii) the display driver IC transmits the t2-nd display sync signal and the t2-nd display data to the display panel having in-pixel memory, to thereby instruct the display panel having in-pixel memory to update the t1-st display data stored in the in-pixel memories to the t2-nd display data, and display a t2-nd video image corresponding to the t2-nd display data updated in the in-pixel memories according to the t2-nd display sync signal.

As one example, at the (III), the display driver IC (i) receives, from the host, a t2-nd MIPI vertical sync signal, and sequentially receives, from the host, a pair of a (t2_1)-st MIPI horizontal sync signal and a (t2_1)-st horizontal video data to a pair of a (t2_p)-th MIPI horizontal sync signal and a (t2_p)-th horizontal video data, each corresponding to each of p display lines in the display panel having in-pixel memory, wherein p is an integer greater than or equal to 1, and wherein the (t2_1)-st horizontal video data is in sync with the (t2_1)-st MIPI horizontal sync signal and the (t2_p)-th horizontal video data is in sync with the (t2_p)-th MIPI horizontal sync signal, and (ii) at a time of receiving a (t2_k)-th MIPI horizontal sync signal and a (t2_k)-th horizontal video data from the host, wherein k is an integer greater than or equal to 1 and less than or equal to p, (ii-1) synchronizes the (t2_k)-th MIPI horizontal sync signal with a (t2_k)-th display horizontal sync signal, (ii-2) generates a (t2_k)-th horizontal display data by referring to the (t2_k)-th horizontal video data, and (ii-3) transmits the (t2_k)-th horizontal display sync signal and the (t2_k)-th horizontal display data to the display panel having in-pixel memory, to thereby instruct the display panel having in-pixel memory to update the (t2_k)-th horizontal display data in the in-pixel memories, which are included in the k-th display line.

As one example, at the (III), the display driver IC transmits the (t2_k)-th horizontal display data in parallel to the display panel having in-pixel memory by using a shift register or a line buffer, to thereby instruct the display panel having in-pixel memory to simultaneously store the (t2_k)-th horizontal display data in the in-pixel memories, which are included within the k-th display line.

As one example, at the (III), the display driver IC generates the t2-nd display data as n bit data, wherein n is an integer greater than or equal to 2, to thereby (i) update each of the in-pixel memories to the t2-nd display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

As one example, at the (I), the display driver IC receives, from the host, a t1-st MIPI vertical sync signal, and sequentially receives, from the host, a pair of a (t1_1)-st MIPI horizontal sync signal and a (t1_1)-st horizontal video data to a pair of a (t1_p)-th MIPI horizontal sync signal and a (t1_p)-th horizontal video data, each of which corresponds to each of p display lines in the display panel having in-pixel memory, wherein the (t1_1)-st horizontal video data is in sync with the (t1_1)-st MIPI horizontal sync signal and the (t1_p)-th horizontal video data is in sync with the (t1_p)-th MIPI horizontal sync signal, and (ii) at a time of receiving a (t1_k)-th MIPI horizontal sync signal and a (t1_k)-th horizontal video data from the host, wherein k is an integer greater than or equal to 1 and less than or equal to p, (ii-1) synchronizes the (t1_k)-th MIPI horizontal sync signal with a (t1_k)-th horizontal display sync signal, (ii-2) generates a (t1_k)-th horizontal display data by referring to the (t1_k)-th horizontal video data, and (ii-3) transmits the (t1_k)-th horizontal display sync signal and the (t1_k)-th horizontal display data to the display panel having in-pixel memory, to thereby instruct the display panel having in-pixel memory to update the in-pixel memories, which are included within the k-th display line, to the (t1_k)-th horizontal display data.

As one example, at the (I), the display driver IC transmits the (t1_k)-th horizontal display data in parallel to the display panel having in-pixel memory by using a shift register or a line buffer, to thereby instruct the display panel having in-pixel memory to simultaneously store the (t1_k)-th horizontal display data in the in-pixel memories, which are included within the k-th display line.

As one example, at the (I), the display driver IC generates the t1-st display data as an n bit data, wherein n is an integer greater than or equal to 2, to thereby (i) update each of the in-pixel memories to the t1-st display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

As one example, at the (II), the display driver IC, when generating the t11-th display sync signal corresponding to the pre-set condition, generates the t11-th display sync signal to have a frequency that is different from a frequency of the t1-st MIPI sync signal. In addition, recordable media that are readable by a computer for storing a computer program to execute the method of the present disclosure is further provided.

### BRIEF DESCRIPTION OF THE DRAWINGS

The following drawings to be used for explaining example embodiments of the present disclosure are only part of example embodiments of the present disclosure and other drawings can be acquired based on the drawings by those skilled in the art of the present disclosure without inventive work.

FIG. 1 is a drawing schematically illustrating a display system in accordance with one example embodiment of the present disclosure.

FIG. 2 is a drawing illustrating the display system in detail in accordance with one example embodiment of the present disclosure.

FIG. 3 is a drawing illustrating a display panel having in-pixel memory of the display system in accordance with one example embodiment of the present disclosure.

FIG. 4 is a drawing illustrating pixels included in the display panel having in-pixel memory of the display system in accordance with one example embodiment of the present disclosure.

FIG. 5 is a drawing illustrating sequences of driving pixels of the display panel having in-pixel memory of the display system in accordance with one example embodiment of the present disclosure.

FIG. 6 is a drawing illustrating sequences of driving the display system at low power in accordance with one example embodiment of the present disclosure.

FIG. 7 is a drawing illustrating sequences of driving the display system at low power in accordance with another example embodiment of the present disclosure.

FIG. 8 is a drawing illustrating sequences of driving the display system at low power in accordance with still another example of the present disclosure.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the spirit and scope of the present invention. In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

To allow those skilled in the art to carry out the present invention easily, the example embodiments of the present invention by referring to attached diagrams will be explained in detail as shown below.

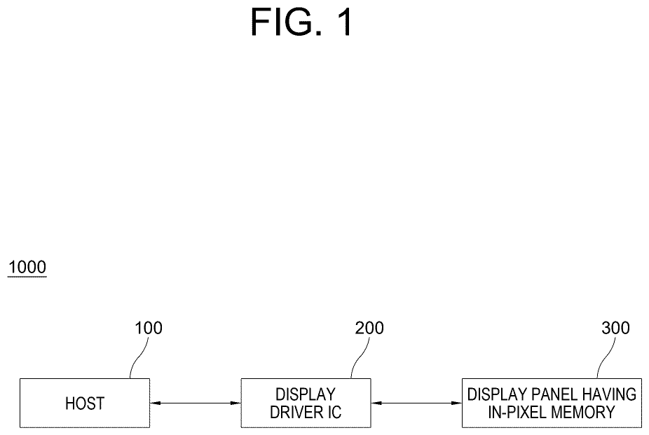

FIG. 1 is a drawing schematically illustrating a display system in accordance with one example embodiment of the present disclosure. By referring to FIG. 1, it can be seen that the display system 1000 includes a host 100, a display driver IC 200, and a display panel having in-pixel memory 300.

Further, the display system 1000 may be implemented as a portable device in accordance with one example embodiment of the present disclosure. Examples of the portable device may include, but are not limited to, mobile phones, smart phones, smart glasses, AR (i.e., Augmented Reality) equipped devices, VR (i.e., Virtual Reality) equipped devices, MR (i.e., Mixed Reality) equipped devices, XR (i.e., Extended Reality) equipped devices, tablet PCs, PDAs (i.e., personal digital assistants), EDAs (i.e., enterprise digital assistants), digital still cameras, digital video cameras, PMPs (i.e., portable multimedia players), PNDs (i.e., personal navigation devices or portable navigation devices), handheld game consoles, e-books, wearable devices, etc.

Meanwhile, the host 100 of the display system 1000 controls an overall operation of the display system 1000, and may be implemented as a system on chip (i.e., SoC), an application processor (i.e., AP), a mobile AP, etc. It may transmit a video data to be displayed to the display driver IC 200.

Further, the display driver IC 200 of the display system 1000 may process the video data transmitted from the host 100 to thereby generate a display data and transmit the display data to an MIP display panel 300 (i.e., the display panel having in-pixel memory 300).

Then, the display panel having in-pixel memory 300 of the display system 1000 may display a video corresponding to the display data transmitted from the display driver IC 200.

Herein, the display panel having in-pixel memory 300 is a display panel having at least one memory such as a random access memory (i.e., RAM), DRAM, SRAM, shift register, etc. formed in each of pixels of a TFT-LCD (i.e., thin film transistor-liquid crystal display) panel, an LED (i.e., light emitting diode) display panel, an OLED (i.e., organic LED) display panel, or an AMOLED (i.e., active matrix OLED) display panel, and may store the display data transmitted from the display driver IC 200 in the memory and may drive each of the pixels using the display data stored in the memory, to thereby display the video.

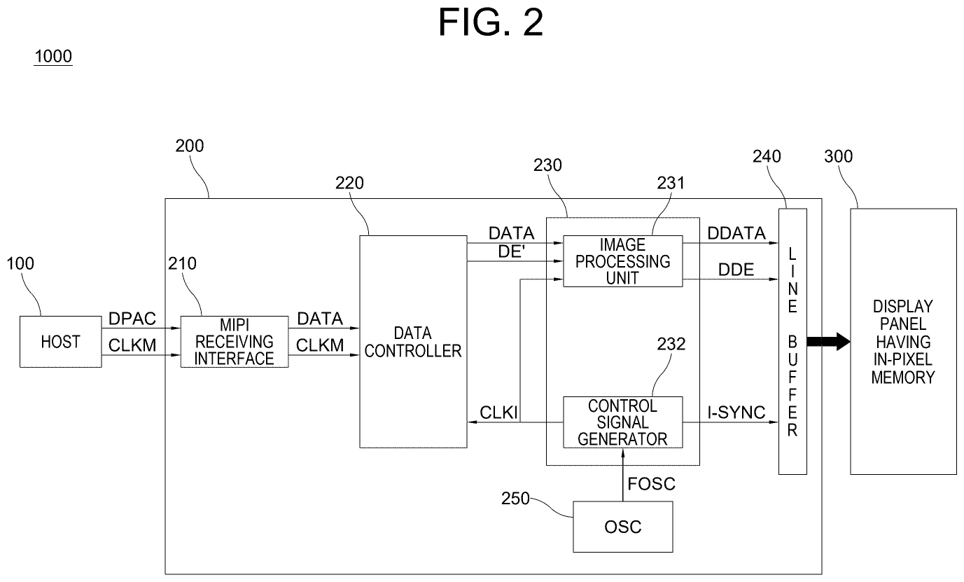

Detailed processes for displaying the video on the display system 1000 are described in detail with reference to FIG. 2 as follows.

The host 100 may transmit each video data synchronized according to a host clock CLKm whenever both a MIPI sync signal and a data enable signal DE are activated. That is, the host 100 may transmit the MIPI sync signal, the data enable signal DE and the video data synchronized with the MIPI sync signal, for each of frames of the video according to the host clock CLKm.

Herein, the host 100 may distinguish the frames by using a MIPI vertical sync signal for each of the frames, and may sequentially transmit a pair of a (t2_1)-st MIPI horizontal sync signal and a (t2_1)-st horizontal video data synchronized therewith to a pair of a (t2_p)-th MIPI horizontal sync signal and a (t2_p)-th horizontal video data synchronized therewith, each of which corresponds to each of p display lines in the display panel having in-pixel memory 300. That is, the host 100 may divide the video data corresponding to a frame into p horizontal video data to thereby transmit them to a video stream DPAC.

Afterwards, a MIPI receiving interface 210 of the display driver IC 200 may refer to the video stream DPAC and the host clock CLKm received from the host 100 to thereby restore a video data DATA from the video stream DPAC based on the host clock CLKm, and then transmit the video data DATA and the host clock CLKm to a data controller 220.

For example, the MIPI receiving interface 210 may restore the MIPI vertical sync signal, the MIPI horizontal sync signal, the data enable signal DE, and the video data DATA from the video stream DPAC by using the host clock CLKm, to thereby transmit them to the data controller 220.

Additionally, the data controller 220 of the display driver IC 200 may generate a data enable signal DE′ by using a display clock CLKi, and transmit the data enable signal DE′ and the video data DATA to a timing controller 230. Herein, the display clock CLKi may be generated by using an internal clock fosc generated from an oscillator 250. For reference, a frequency of the display clock CLKi and a frequency of the internal clock fosc may be the same or different from each other.

Then, the timing controller 230 may generate (1) a display sync signal i-Sync that is synchronized with the MIPI sync signal based on the display clock CLKi, (2) a display data DDATA by processing the video data DATA, and (3) a display data enable signal DDE to be used for transmitting the display data DDATA.

For example, the timing controller 230 may generate both the display clock CLKi and the display sync signal i-Sync based on the internal clock fosc through a control signal generator 232. Herein, the control signal generator 232 may generate (1) a vertical display sync signal corresponding to each of the frames and (2) a horizontal display sync signal corresponding to each of the horizontal video data, based on the internal clock fosc.

In addition, the timing controller 230 may process the received video data DATA by using the display clock CLKi and the data enable signal DE′ through an image processing unit 231, to thereby generate the display data DDATA. Herein, the image processing unit 231 may perform an image enhancement process and/or an image editing process, thereby adjusting a brightness, contrast, saturation, or a sharpness of the video data DATA and thus generating the display data DDATA. Further, the display data DDATA may be an n-bit data, wherein n is an integer greater than or equal to 2, corresponding to pixel values of each of the pixels.

Thereafter, the timing controller 230 may transmit the display data DDATA, an display data enable signal DDE, and the display sync signal i-Sync to the display panel having in-pixel memory 300; and the display panel having in-pixel memory 300 may store or update the display data DDATA in each of in-pixel memories formed in each of the pixels, to thereby drive each of light-emitting elements according to the display data DDATA stored in each of the in-pixel memories based on the display sync signal i-Sync and thus display a video image.

Herein, the display driver IC 200 may transmit the display data DDATA, the display data enable signal DDE, and the display sync signal i-Sync to the display panel having in-pixel memory 300 through a line buffer 240. Herein, a shift register, etc., may be used instead of the line buffer 240.

For example, the line buffer 240 may store the display data DDATA according to the display data enable signal DDE and transmit the displayed data DDATA, which is stored according to the display sync signal i-Sync, to the display panel having in-pixel memory 300. That is, the line buffer 240 may transmit the horizontal display data in parallel to the display panel having in-pixel memory 300. Therefore, in response to receiving all of the horizontal display data, the line buffer 240 may transmit all of the received horizontal display data to the display panel having in-pixel memory 300, thereby allowing the video image to be displayed on the display panel having in-pixel memory 300 for each of the horizontal display data.

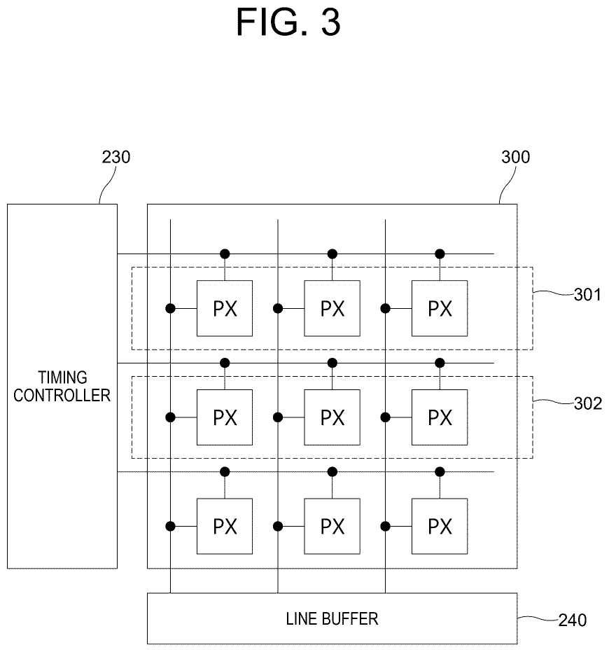

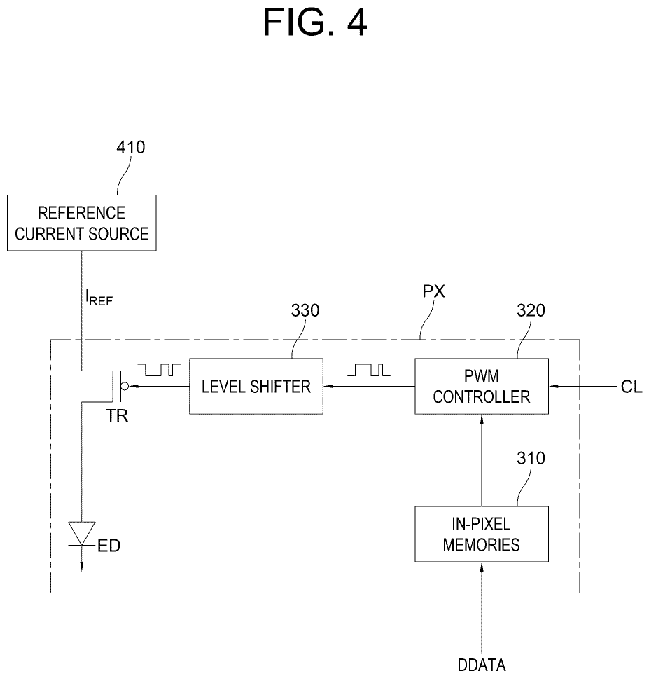

Further, more details of the display panel having in-pixel memory 300 will be explained by referring to FIGS. 3 and 4.

Upon receiving the display data DDATA, that is, each of the horizontal display data including each of the n-bit data representing gradation for each of pixel values corresponding to each of the pixels of the video data, from the timing controller 230 of the display driver IC 200, the display panel having in-pixel memory 300 may store each of the horizontal display data in each of the in-pixel memories 310 located in each of horizontal lines 301, 302 of the display panel having in-pixel memory 300.

Herein, one frame of the video data may be comprised of n sub-frames, and a length of each of sub-frames may be different. For example, a length of a sub-frame corresponding to an MSB (i.e., most significant bit) of the display data DDATA may be set to have a longest length, and a length of a sub-frame corresponding to an LSB (i.e., least significant bit) may be set to have a shortest length. Also, an order of a first sub-frame to an n-th sub-frame may correspond to an order of the MSB to the LSB. However, the present invention is not limited thereto, and the order of the sub-frames may be set in various order by those skilled in the art.

Afterwards, a PWM controller 320 of the display panel having in-pixel memory 300 may generate a PWM signal by using (1) a clock signal transmitted from the timing controller 230 of the display driver IC 200 and (2) bit values of the n-bit data stored in the in-pixel memories 310. That is, in response to receiving a clock signal CL of a sub-frame from the timing controller 230, the PWM controller 320 may generate the PWM signal by using bit values of the display data DDATA corresponding to the clock signal CL.

Herein, the PWM controller 320 may control a pulse width of the PWM signal based on (1) a bit value of the display data for a sub-frame and (2) a signal width of the clock signal CL. For example, if the bit value of the display data DDATA is 1, a pulse output of the PWM signal may be turned on as much as the signal width of the clock signal CL, and if the bit value of the display data DDATA is 0, the pulse output of the PWM signal may be turned off as much as the signal width of the clock signal CL. That is, an on-duty time for the pulse output of the PWM signal and an off-duty time for the pulse output of the PWM signal may be determined by the signal width (i.e., a signal length) of the clock signal CL.

Further, the PWM signal generated from the PWM controller 320 may control an on/off operation of a transistor TR that is used to control a reference current Iref supplied from a reference current source 410 to light-emitting elements EDs by voltage step-up through a level shifter 330, and accordingly, an amount of a current supplied to the light-emitting elements EDs may be controlled by the on/off operation of the transistor TR according to the PWM signal, thereby allowing the light-emitting elements EDs to display the gradation of the video data corresponding to the pixels. Herein, the reference current source 410 may be implemented in various ways, such as by generating a common reference current to be supplied to multiple pixels through a current mirror.

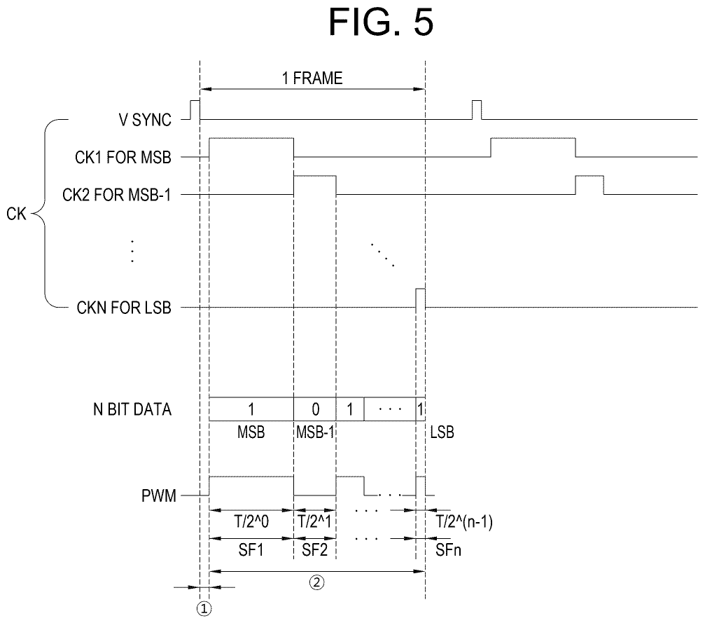

FIG. 5 provides more details of driving the light-emitting elements of each of the pixels.

A pixel PX may be driven during one frame comprised of a data writing period \textcircled{1} and a light emitting period \textcircled{2}. The light emitting period \textcircled{2} may be divided into a first sub-frame SF1 to an n-th sub-frame SFn.

During the data writing period \textcircled{1}, the bit values of the n-bit data, i.e., the display data DDATA, may be stored in the in-pixel memories 310.

In each of sub-frames in the light-emitting period \textcircled{2}, clock signals CK may be applied to the PWM controller 320, and the PWM controller 320 may generate the PWM signal based on the clock signals CK and the bit values of the display data DDATA stored in the in-pixel memories 310.

Herein, each time length allocated to each of the first sub-frame SF1 to the n-th sub-frame SFn may be different. For example, a first length of T/2\hat{ }0 may be allocated to the first sub-frame SF1, a second length of T/2\hat{ }1 may be allocated to a second sub-frame SF2, a third length of T/2\hat{ }2 may be allocated to a third sub-frame SF3, and an n-th length of T/2\hat{ }(n−1) may be allocated to the n-th sub-frame SFn, but they are not limited thereto.

Further, the display data DDATA may be represented as the n-bits of from the MSB to the LSB, and the order of the MSB to LSB may correspond to an order of the first sub-frame SF1 to the n-th sub-frame SFn.

Furthermore, the clock signals CK may include a first clock signal CK1 to an n-th clock signal CKn, and the first clock signal CK1 to the n-th clock signal CKn may be sequentially outputted according to the order of the first sub-frame SF1 to the n-th sub-frame SFn.

Herein, each of length of the clock signals CK may be different for each of the sub-frames. For example, the first clock signal CK1 corresponding to the first sub-frame SF1 allocated to the MSB of the display data DDATA may have the first length T/2\hat{ }0, and a second clock signal CK2 corresponding to the second sub-frame SF2 allocated to a MSB-1 (i.e., a second most significant bit) of the display data DDATA may have the second length T/2\hat{ }1, and the n-th clock signal CKn corresponding to the n-th sub-frame SFn allocated to the LSB of the display data DDATA may have the n-th length T/2\hat{ }(n−1), however, they are not limited thereto.

Moreover, for each of the first sub-frame SF1 to the n-th sub-frame SFn, the PWM controller 320 may read each corresponding bit value of the display data DDATA from a corresponding memory-in-pixel 310 and generate the PWM signal with an adjusted pulse width based on a signal width of the clock signals CK and the each corresponding bit value of the display data DDATA.

For reference, FIG. 5 illustrates the display data DDATA with the n-bit values 101 . . . 1, and the PWM controller 320 may output a pulse with a first length of T based on a bit value “1” of the MSB of the display data DDATA and the first clock signal CK1. Additionally, the PWM controller 320 may turn off a pulse output for the second length T/2 based on a bit value “0” of the MSB-1 of the display data DDATA and the second clock signal CK2. Further, the PWM controller 320 may output a pulse having a pulse width of the n-th length of T/2\hat{ }(n−1) based on a bit value “1” of the LSB of the display data DDATA and the n-th clock signal CKn.

Therefore, the light-emitting elements EDs may emit light or not emit light depending on a pulse output of the PWM signal during one frame. That is, the light-emitting elements EDs may emit light for a period of time corresponding to a pulse width when the pulse output is turned on and may not emit light while the pulse output is turned off.

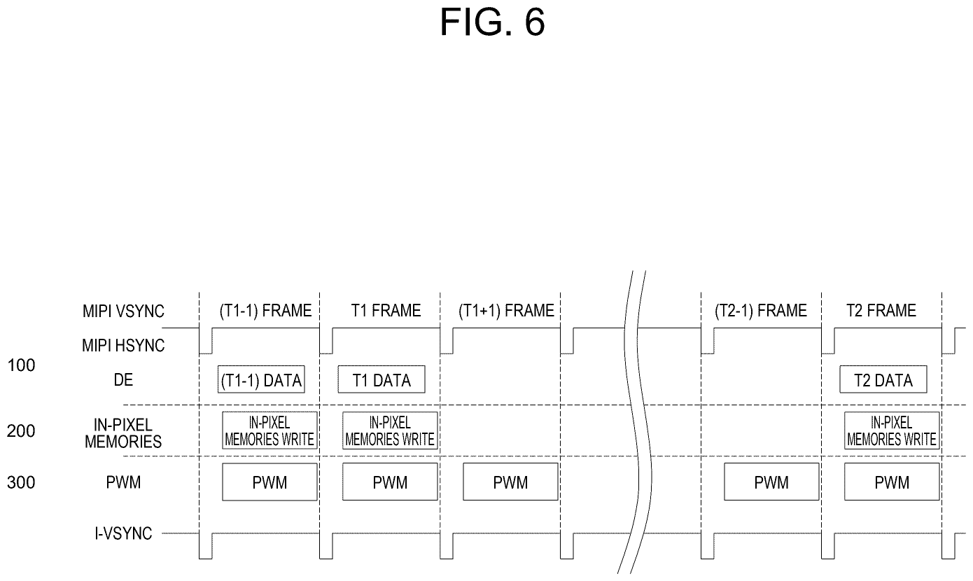

A method of driving the display system at low power according to one embodiment of the present disclosure as described above will be described with reference to FIG. 6 as below. In the following description, detailed descriptions of parts that can be easily understood from an operation process of the display system described with reference to FIGS. 1 to 5 above will be omitted.

According to FIGS. 1 to 5, while the display driver IC 200 is displaying the video through the display panel having in-pixel memory 300 (after the video data synchronized with a host clock was transmitted to the display driver IC 200 by the host 100), in order to drive in low power, i.e., in order to execute a so-called ECO mode, the host 100 may not transmit the video data related to a still image but only send a MIPI sync signal in a porch region. Herein, unlike a conventional MIPI video mode where a host has to repeatedly transmit the video data of the still image, the host 100 may reduce its power consumption by only transmitting the MIPI sync signal and not transmitting additional video data of the still image.

Specifically, the host 100 may synchronize a t1-st MIPI sync signal (i.e., t1 MIPI VSync, t1 MIPI HSync), which correspond to a t1-st frame, and a t1-st video data t1 DATA, which is in sync with the t1-st MIPI sync signal, with the host clock, to thereby transmit them.

Then, the display driver IC 200 may (1) synchronize the t1-st MIPI sync signal (i.e., t1 MIPI VSync, t1 MIPI HSync) with a t1-st display sync signal t1 i-VSync, (2) generate a t1-st display data corresponding to the t1-st frame by referring to the t1-st video data t1 DATA, and (3) transmit the t1-st display sync signal t1 i-VSync and the t1-st display data to the display panel having in-pixel memory 300, to thereby allow the t1-st display data to be stored in the in-pixel memories of the display panel having in-pixel memory 300. Herein, on condition that a (t1_1)-st display data corresponding to a (t1_1)-st frame is stored in the in-pixel memories, the (t1_1)-st display data stored in the in-pixel memories may be updated to the t1-st display data.

For example, the display driver IC 200 may receive a t1-st MIPI vertical sync signal t1 MIPI VSync from the host 100, and sequentially receive, from the host 100, a pair of a (t1_1)-st MIPI horizontal sync signal t1_1 MIPI HSync and a (t1_1)-st horizontal video data t1_1 DATA to a pair of a (t1_p)-th MIPI horizontal sync signal t1_p MIPI HSync and a (t1_p)-th horizontal video data t1_p DATA, each of which corresponds to each of the p display lines in the display panel having in-pixel memory 300. Herein, the (t1_1)-st horizontal video data t1_1 DATA may be in sync with the (t1_1)-st MIPI horizontal sync signal t1_1 MIPI HSync and the (t1_p)-th horizontal video data t1_p DATA may be in sync with the (t1_p)-th MIPI horizontal sync signal t1_p MIPI HSync.

Further, the display driver IC 200, at a time of receiving a (t1_k)-th MIPI horizontal sync signal t1_k MIPI HSync and a (t1_k)-th horizontal video data t1_k DATA from the host 100, may (1) synchronize the (t1_k)-th MIPI horizontal sync signal t1_k MIPI HSync with a (t1_k)-th horizontal display sync signal t1_k i-HSync, (2) generate a (t1_k)-th horizontal display data by referring to the (t1_k)-th horizontal video data t1_k DATA, and (3) transmit the (t1_k)-th horizontal display sync signal t1_k i-HSync and the (t1_k)-th horizontal display data to the display panel having in-pixel memory 300, to thereby store the (t1_k)-th horizontal display data in the in-pixel memories, which are included within a k-th display line. Herein k is an integer greater than or equal to 1 and less than or equal to p.

Herein, the display driver IC 200 may transmit the (t1_k)-th horizontal display data in parallel to the display panel having in-pixel memory 300 by using a shift register or a line buffer, to thereby simultaneously allow the (t1_k)-th horizontal display data to be stored in the in-pixel memories, which are included within the k-th display line.

Then, the display panel having in-pixel memory 300 may display a t1-st video image corresponding to the t1-st display data stored in the in-pixel memories according to the t1-st display sync signal t1 i-VSync.

For example, the display driver IC 200 may generate the t1-st display data as the n-bit data, to thereby (i) update each of the in-pixel memories to the t1-st display data as the n-bit data, (ii) instruct the display panel having in-pixel memory 300 to convert the n-bit data into the PWM signal, and (iii) drive each of the light-emitting elements corresponding to each of the pixels by using the PWM signal.

Considering the above, the host 100, after the t1-st frame, which is the still image, may not transmit the video data corresponding to a (t1+1)-th frame and only transmit a (t1+1)-th MIPI sync signal (i.e., (t1+1)-th MIPI VSync, (t1+1)-th MIPI HSync).

Then the display driver IC 200 may, from the host 100, only receive the (t1+1)-th MIPI sync signal (i.e., (t1+1) MIPI VSync, (t1+1) MIPI HSync) without requiring video data corresponding to the (t1+1)-th frame. Accordingly, the display driver IC 200 may synchronize the (t1+1)-th MIPI sync signal (i.e., (t1+1) MIPI VSync, (t1+1) MIPI HSync) with (t1+1)-th display sync signal (t1+1) i-VSync, and transmit the (t1+1)-th display sync signal (t1+1) i-Vsync to the display panel having in-pixel memory 300, to thereby instruct the display panel having in-pixel memory 300 to display the t1-st video image (i.e., the still image) corresponding to the t1-st display data stored in the in-pixel memories according to the (t1+1)-th display sync signal (t1+1) i-VSync.

Herein, a frequency of the (t1+1) MIPI sync signal (i.e., (t1+1) MIPI VSync, (t1+1) MIPI HSync) may be same as a frequency of the t1-st MIPI sync signal (i.e., t1 MIPI VSync, t1 MIPI HSync), but preferably, they may be of different frequencies. For example, the frequency of the the t1-st MIPI sync signal (i.e., t1 MIPI VSync, t1 MIPI HSync) may be 120 Hz, while the frequency of (t1+1) MIPI sync signal (i.e., (t1+1) MIPI VSync, (t1+1) MIPI HSync) may be 1 Hz.

While displaying the still image by the method as explained above, in order to replay the video, i.e., in order to terminate the ECO mode, the host 100 may transmit (1) a t2-nd MIPI sync signal (i.e., t2 MIPI VSync, t2 MIPI HSync) corresponding to a t2-nd frame and (2) a t2-nd video data t2 DATA corresponding to the t2-nd frame and synced with the t2-nd MIPI sync signal, by synchronizing them with the host clock.

Then, the display driver IC 200 may synchronize the t2-nd MIPI sync signal (i.e., t2 MIPI VSync, t2 MIPI HSync) with the t2-nd display sync signal t2 i-VSync, generate t2-nd display data corresponding to the t2-nd frame by referring to the t2-nd video data t2 DATA, and transmit the t2-nd display sync signal t2 i-VSync and t2-nd display data to the display panel having in-pixel memory 300, to thereby store the t2-nd display data in the in-pixel memories of the display panel having in-pixel memory 300. Herein, the t1-st display data stored in the in-pixel memories may be updated to the t2-nd display data.

For example, the display driver IC 200 may receive a t2-nd MIPI vertical sync signal t2 MIPI VSync from the host 100, and sequentially receive, from the host 100, a pair of a (t2_1)-st MIPI horizontal sync signal (t2_1) MIPI HSync and a (t2_1)-st horizontal video data t2_1 DATA to a pair of a (t2_p)-th MIPI horizontal sync signal t2_p MIPI HSync and a (t2_p)-th horizontal video data t2_p DATA, each of which corresponds to each of the p display lines in the display panel having in-pixel memory 300. Herein the (t2_1)-st horizontal video data t2_1 DATA may be in sync with the (t2_1)-st MIPI horizontal sync signal t2_1 MIPI HSync and the (t2_p)-th horizontal video data t2_p DATA may be in sync with the (t2_p)-th MIPI horizontal sync signal t2_p MIPI HSync.

Further, the display driver IC 200, at a time of receiving a (t2_k)-th MIPI horizontal sync signal t2_k MIPI HSync and a (t2_k)-th horizontal video data t2_k DATA from the host 100, may (1) synchronize the (t2_k)-th MIPI horizontal sync signal t2_k MIPI HSync with a (t2_k)-th horizontal display sync signal t2_k i-HSync, (2) generate a (t2_k)-th horizontal display data by referring to the (t2_k)-th horizontal video data t2_k DATA, and (3) transmit the (t2_k)-th horizontal display sync signal t2_k i-HSync and the (t2_k)-th horizontal display data to the display panel having in-pixel memory 300, to thereby update the (t1_k)-th horizontal display data stored in the in-pixel memories, which are included within the k-th display line, to the (t2_k)-th horizontal display data. Herein k is an integer greater than or equal to 1 and less than or equal to p.

Herein, the display driver IC 200 may transmit the (t2_k)-th horizontal display data in parallel to the display panel having in-pixel memory 300 by using the shift register or the line buffer, to thereby allow the (t2_k)-th horizontal display data to be simultaneously stored in the in-pixel memories, which are included within the k-th display line.

Then, the display panel having in-pixel memory 300 may display a t2-nd video image corresponding to the t2-nd display data stored in the in-pixel memories according to the t2-nd display sync signal t2 i-VSync.

For example, the display driver IC 200 may generate the t2-nd display data as the n bit data, to thereby (i) update each of the in-pixel memories to the t2-nd display data, which is the n bit data, (ii) instruct the display panel having in-pixel memory 300 to convert the n-bit data into the PWM signal, and (iii) drive each of the light-emitting elements corresponding to each of the pixels by using the PWM signal.

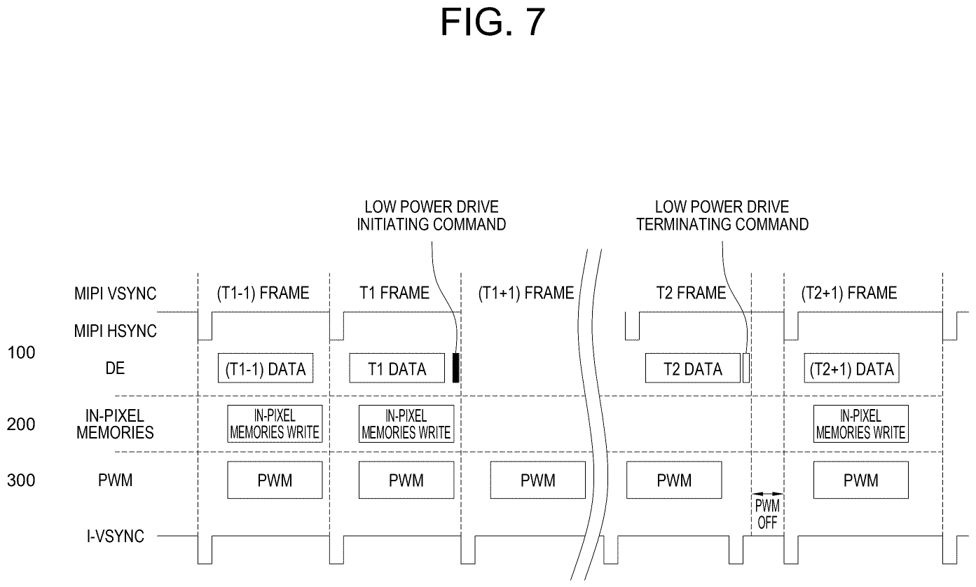

Next, another method of driving the display system at low power as described above by referring to FIGS. 1 to 5 will be described with reference to FIG. 7 as below. In the following description, same symbols may be used for detailed descriptions of parts that are same or similar to those in the low-power driving method described with reference with FIG. 6.

According to FIGS. 1 to 5, while the display driver IC 200 is displaying the video through the display panel having in-pixel memory 300 (after the video data synchronized with a host clock was transmitted to the display driver IC 200 by the host 100), in order to drive in low power, i.e., in order to execute a so-called ECO mode, the host 100 may not transmit the video data related to a still image but only send a low power drive initiating command (i.e., ECO mode initiating command) in a porch region. Herein, unlike a conventional MIPI video mode where a host has to repeatedly transmit the video data of the still image, the host 100 may reduce its power consumption by only transmitting the low power drive initiating command and not transmitting additional video data of the still image.

Specifically, the host 100 may synchronize a t1-st MIPI sync signal (i.e., t1 MIPI VSync, t1 MIPI HSync) and a t1-st video data t1 DATA, which correspond to a t1-st frame, with the host clock, to thereby transmit them. Herein, the t1-st video data is in sync with the t1-st MIPI sync signal.

Then, the display driver IC 200 may (1) synchronize the t1-st MIPI sync signal (i.e., t1 MIPI VSync, t1 MIPI HSync) with a t1-st display sync signal t1 i-VSync, (2) generate a t1-st display data corresponding to the t1-st frame by referring to the t1-st video data t1 DATA, and (3) transmit the t1-st display sync signal t1 i-VSync and the t1-st display data to the display panel having in-pixel memory 300, to thereby allow the t1-st display data to be stored in the in-pixel memories of the display panel having in-pixel memory 300. Herein, on condition that a (t1_1)-st display data corresponding to a (t1_1)-st frame is stored in the in-pixel memories, the (t1_1)-st display data stored in the in-pixel memories may be updated to the t1-st display data.

For example, the display driver IC 200 may receive a t1-st MIPI vertical sync signal t1 MIPI VSync from the host 100, and sequentially receive, from the host 100, a pair of a (t1_1)-st MIPI horizontal sync signal t1_1 MIPI HSync and a (t1_1)-st horizontal video data t1_1 DATA to a pair of a (t1_p)-th MIPI horizontal sync signal t1_p MIPI HSync and a (t1_p)-th horizontal video data t1_p DATA, each of which corresponds to each of the p display lines in the display panel having in-pixel memory 300. Herein, the (t1_1)-st horizontal video data t1_1 DATA may be in sync with the (t1_1)-st MIPI horizontal sync signal t1_1 MIPI HSync and the (t1_p)-th horizontal video data t1_p DATA may be in sync with the (t1_p)-th MIPI horizontal sync signal t1_p MIPI HSync.

Further, the display driver IC 200, at a time of receiving a (t1_k)-th MIPI horizontal sync signal t1_k MIPI HSync and a (t1_k)-th horizontal video data t1_k DATA from the host 100, may (1) synchronize the (t1_k)-th MIPI horizontal sync signal t1_k MIPI HSync with a (t1_k)-th horizontal display sync signal t1_k i-HSync, (2) generate a (t1_k)-th horizontal display data by referring to the (t1_k)-th horizontal video data t1_k DATA, and (3) transmit the (t1_k)-th horizontal display sync signal t1_k i-HSync and the (t1_k)-th horizontal display data to the display panel having in-pixel memory 300, to thereby store the (t1_k)-th horizontal display data in the in-pixel memories, which are included within a k-th display line. Herein k is an integer greater than or equal to 1 and less than or equal to p.

Herein, the display driver IC 200 may transmit the (t1_k)-th horizontal display data in parallel to the display panel having in-pixel memory 300 by using a shift register or a line buffer, to thereby simultaneously allow the (t1_k)-th horizontal display data to be stored in the in-pixel memories, which are included within the k-th display line.

Then, the display panel having in-pixel memory 300 may display a t1-st video image corresponding to the t1-st display data stored in the in-pixel memories according to the t1-st display sync signal t1 i-VSync.

For example, the display driver IC 200 may generate the t1-st display data as the n-bit data, to thereby (i) update each of the in-pixel memories to the t1-st display data as the n-bit data, (ii) instruct the display panel having in-pixel memory 300 to convert the n-bit data into the PWM signal, and (iii) drive each of the light-emitting elements corresponding to each of the pixels by using the PWM signal.

Considering the above, in order to drive at low power, after the t1-st frame when the still image is displayed, the host 100 may transmit the low power drive initiating command for the t1-st porch region corresponding to the t1-st sync signal, i.e., a time region between a time of transmitting the t1-st video data and a time of transmitting a (t1+1)-th video data, and then the host 100 may not transmit a (t1+1)-th MIPI sync signal corresponding to a (t1+1)-th frame and a (t1+1)-th video data corresponding to the (t1+1)-th frame.

Then the display driver IC 200 may transmit the (t1+1)-th display sync signal (t1+1) i-VSync corresponding to the t1-st display sync signal t1 i-VSync, which is a current display sync signal, to the display panel having in-pixel memory 300, to thereby instruct the display panel having in-pixel memory 300 to display the t1-st video image (i.e., the still image) corresponding to the t1-st display data stored in the in-pixel memories according to the (t1+1)-th display sync signal (t1+1) i-VSync.

Herein, a frequency of the (t1+1) display sync signal (t1+1) i-VSync may be same as a frequency of the t1-st display sync signal t1 i-VSync, but preferably, they may be of different frequencies. For example, the frequency of the t1-st display sync signal t1 i-VSync may be 120 Hz, while the frequency of the (t1+1)-th display sync signal (t1+1) i-VSync may be 1 Hz.

While displaying the still image by the method as explained above, in order to replay the video, i.e., in order to terminate the ECO mode, the host 100 may transmit (1) (1-1) a t2-nd MIPI sync signal (i.e., t2 MIPI VSync, t2 MIPI HSync) corresponding to a t2-nd frame and (1-2) a t2-nd video data t2 DATA, which is synchronized with the t2-nd MIPI sync signal, corresponding to the t2-nd frame, by syncing them with the host clock, and then (2) a low power drive terminating command (i.e., an ECO mode terminating command) for a t2-nd porch region corresponding to the t2-nd MIPI sync signal (i.e., t2 MIPI VSync, t2 MIPI HSync).

Herein, the t2-nd MIPI sync signal, transmitted from the host 100, may have not been synchronized with the (t1+1)-th display sync signal that is currently driving the memory-in-pixel type display 300. Further, the host 100 may transmit the t2-nd MIPI sync signal corresponding to the t2-nd frame and the t2-nd video data corresponding to the t2-nd frame, which may be information required to wake up the display driver IC 200 in order to transmit the low power drive terminating command for the t2-nd porch region. Furthermore, the t2-nd video data may be the same video data as the t1-st video data corresponding to the t1-st display data, which is the still image displayed on the display panel having in-pixel memory 300, but the present invention is not limited thereto.

Then, the display driver IC 200 may block the t1-st video image from being displayed on the display panel having in-pixel memory 300 in response to the low power drive terminating command. That is, by allowing the display driver IC 200 not to transmit the (t1+1)-th display sync signal, the display panel having in-pixel memory 300 may block the light-emitting elements, which are driven by PWM, from displaying the gradation, thereby not displaying the video.

Afterwards, in response to receiving, from the host 100 after the low power drive terminating command, a (t2+1)-th MIPI sync signal corresponding to a (t2+1)-th frame and a (t2+1)-th video data corresponding to the (t2+1)-th frame, wherein the (t2+1)-th video data is in sync with the (t2+1)-th MIPI sync signal, the display driver IC 200 may (i) synchronize the (t2+1)-th MIPI sync signal (i.e., (t2+1) MIPI VSync, (t2+1) MIPI HSync) with a (t2+1)-th display sync signal (t2+1) i-VSync, (ii) generate a (t2+1)-th display data corresponding to the (t2+1)-th frame by referring to the (t2+1)-th video data (t2+1) DATA, and (iii) transmit the (t2+1)-th display sync signal (t2+1) i-VSync and the (t2+1)-th display data to the display panel having in-pixel memory 300, to thereby store the (t2+1)-th display data in the in-pixel memories of the display panel having in-pixel memory 300. Herein, the t1-st display data stored in the in-pixel memories may be updated to the (t2+1)-th display data.

Herein, a time range of not displaying the video on the display panel having in-pixel memory 300 by turning off a PWM driving of the display panel having in-pixel memory 300 may be included in a time range of from a time of the display driver IC 200 receiving the low power drive terminating command from the host 100 to a time of displaying the (t2+1)-th display data. Herein, the time range of not displaying the video on the display panel having in-pixel memory 300 by turning off a PWM driving of the display panel having in-pixel memory 300 may correspond to a time range of at most one frame depending on when the low power drive terminating command is received during a region of the (t1+1)-th display sync signal that is currently driving the display panel having in-pixel memory 300. For reference, a region of from the (t1+1)-th frame to a t2-nd frame corresponds to the region of the (t1+1)-th display sync signal. That is, if it is assumed that a video image corresponding to the (t2+1)-th frame is to be displayed on the display panel having in-pixel memory 300 immediately after the low power drive terminating command is received from the host 100, and without a synchronization of the display sync signal with the MIPI sync signal of the host 100, the t1-st video data currently being displayed and the (t2+1)-th video data may be mixed together, which may deteriorate a display quality. Therefore, during a region of the display sync signal right after receiving the low power drive terminating command, the display panel having in-pixel memory 300 is set not to display the video image, thereby preventing the video image from being mixed.

For example, the display driver IC 200 may receive a (t2+1)-th MIPI vertical sync signal (t2+1) MIPI VSync from the host 100, and sequentially receive, from the host 100, a pair of a ((t2+1)_1)-st MIPI horizontal sync signal (t2+1)_1 MIPI HSync and a ((t2+1)_1)-st horizontal video data (t2+1)_1 DATA to a pair of a ((t2+1)_p)-th MIPI horizontal sync signal (t2+1)_p MIPI HSync and a ((t2+1)_p)-th horizontal video data (t2+1)_p DATA, each of which corresponds to each of the p display lines in the display panel having in-pixel memory 300. Herein the ((t2+1)_1)-st horizontal video data (t2+1)_1 DATA may be in sync with the ((t2+1)_1)-st MIPI horizontal sync signal (t2+1)_1 MIPI HSync and the ((t2+1)_p)-th horizontal video data (t2+1)_p DATA may be in sync with the ((t2+1)_p)-th MIPI horizontal sync signal (t2+1)_p MIPI HSync.

Further, the display driver IC 200, at a time of receiving a ((t2+1)_k)-th MIPI horizontal sync signal (t2+1)_k MIPI HSync and a ((t2+1)_k)-th horizontal video data (t2+1)_k DATA from the host 100, may (1) synchronize the ((t2+1)_k)-th MIPI horizontal sync signal (t2+1)_k MIPI HSync with a ((t2+1)_k)-th horizontal display sync signal (t2+1)_k i-HSync, (2) generate a ((t2+1)_k)-th horizontal display data by referring to the ((t2+1)_k)-th horizontal video data (t2+1)_k DATA, and (3) transmit the ((t2+1)_k)-th horizontal display sync signal (t2+1)_k i-HSync and the ((t2+1)_k)-th horizontal display data to the display panel having in-pixel memory 300, to thereby update the (t1_k)-th horizontal display data stored in the in-pixel memories, which are included within the k-th display line, to the ((t2+1)_k)-th horizontal display data. Herein k is an integer greater than or equal to 1 and less than or equal to p.

Herein, the display driver IC 200 may transmit the ((t2+1)_k)-th horizontal display data in parallel to the display panel having in-pixel memory 300 by using the shift register or the line buffer, to thereby allow the ((t2+1)_k)-th horizontal display data to be simultaneously stored in the in-pixel memories, which are included within the k-th display line.

Then, the display panel having in-pixel memory 300 may display a (t2+1)-th video image corresponding to the (t2+1)-th display data stored in the in-pixel memories according to the (t2+1)-th display sync signal (t2+1) i-VSync.

For example, the display driver IC 200 may generate the (t2+1)-th display data as the n bit data, to thereby (i) update each of the in-pixel memories to the (t2+1)-th display data, which is the n bit data, (ii) instruct the display panel having in-pixel memory 300 to convert the n-bit data into the PWM signal, and (iii) drive each of the light-emitting elements corresponding to each of the pixels by using the PWM signal.

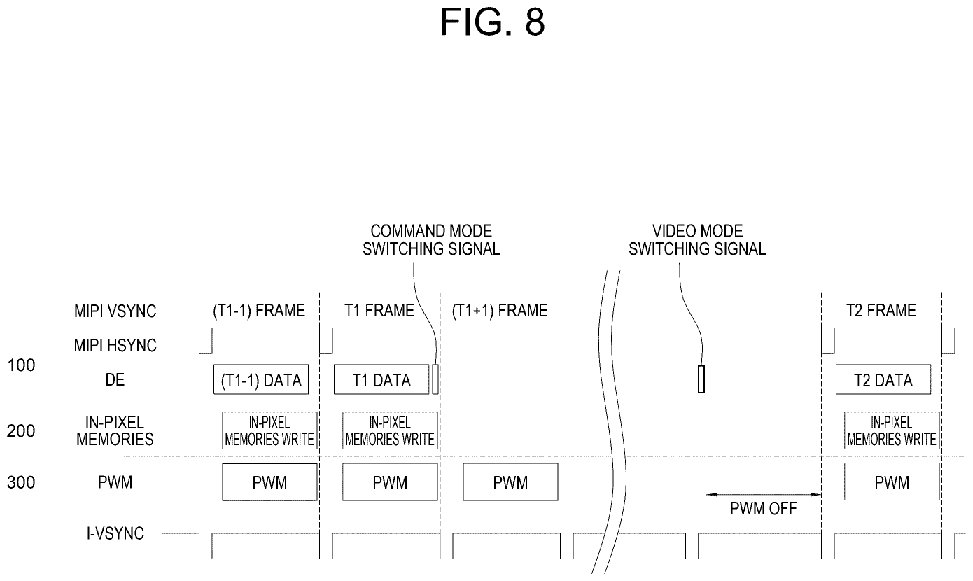

Next, a method of driving the display system at low power as described above by referring to FIGS. 1 to 5 will be described with reference to FIG. 8 as below. In the following description, same symbols may be used for detailed descriptions of parts that are same or similar to those in the low-power driving method described with reference with FIGS. 6 and 7.

As mentioned in the explanation above related to FIGS. 1 to 5, while the display driver IC 200 is displaying the video through the display panel having in-pixel memory 300 (after the video data synchronized with a host clock was transmitted to the display driver IC 200 by the host 100), in order to drive in low power mode, i.e., in order to execute a so-called ECO mode, the host 100 may not transmit the video data related to a still image but send a command mode switching signal. Accordingly, unlike the conventional MIPI video mode where a host has to repeatedly transmit the video data of the still image, the host 100 may reduce its power consumption by transmitting the command mode switching signal and not transmitting additional video data of the still image.

Specifically, the host 100 may synchronize a t1-st MIPI sync signal (i.e., t1 MIPI VSync, t1 MIPI HSync) and a t1-st video data t1 DATA, which correspond to a t1-st frame, with the host clock, to thereby transmit them. Herein, the t1-st video data is in sync with the t1-st MIPI sync signal.

Then, the display driver IC 200 may (1) synchronize the t1-st MIPI sync signal (i.e., t1 MIPI VSync, t1 MIPI HSync) with a t1-st display sync signal t1 i-VSync, (2) generate a t1-st display data corresponding to the t1-st frame by referring to the t1-st video data t1 DATA, and (3) transmit the t1-st display sync signal t1 i-VSync and the t1-st display data to the display panel having in-pixel memory 300, to thereby allow the t1-st display data to be stored in the in-pixel memories of the display panel having in-pixel memory 300. Herein, on condition that a (t1_1)-st display data corresponding to a (t1_1)-st frame is stored in the in-pixel memories, the (t1_1)-st display data stored in the in-pixel memories may be updated to the t1-st display data.

For example, the display driver IC 200 may receive a t1-st MIPI vertical sync signal t1 MIPI VSync from the host 100, and sequentially receive, from the host 100, a pair of a (t1_1)-st MIPI horizontal sync signal t1_1 MIPI HSync and a (t1_1)-st horizontal video data t1_1 DATA to a pair of a (t1_p)-th MIPI horizontal sync signal t1_p MIPI HSync and a (t1_p)-th horizontal video data t1_p DATA, each of which corresponds to each of the p display lines in the display panel having in-pixel memory 300. Herein, the (t1_1)-st horizontal video data t1_1 DATA may be in sync with the (t1_1)-st MIPI horizontal sync signal t1_1 MIPI HSync and the (t1_p)-th horizontal video data t1_p DATA may be in sync with the (t1_p)-th MIPI horizontal sync signal t1_p MIPI HSync.

Further, the display driver IC 200, at a time of receiving a (t1_k)-th MIPI horizontal sync signal t1_k MIPI HSync and a (t1_k)-th horizontal video data t1_k DATA from the host 100, may (1) synchronize the (t1_k)-th MIPI horizontal sync signal t1_k MIPI HSync with a (t1_k)-th horizontal display sync signal t1_k i-HSync, (2) generate a (t1_k)-th horizontal display data by referring to the (t1_k)-th horizontal video data t1_k DATA, and (3) transmit the (t1_k)-th horizontal display sync signal t1_k i-HSync and the (t1_k)-th horizontal display data to the display panel having in-pixel memory 300, to thereby store the (t1_k)-th horizontal display data in the in-pixel memories, which are included within a k-th display line. Herein k is an integer greater than or equal to 1 and less than or equal to p.

Herein, the display driver IC 200 may transmit the (t1_k)-th horizontal display data in parallel to the display panel having in-pixel memory 300 by using a shift register or a line buffer, to thereby simultaneously allow the (t1_k)-th horizontal display data to be stored in the in-pixel memories, which are included within the k-th display line.

Then, the display panel having in-pixel memory 300 may display a t1-st video image corresponding to the t1-st display data stored in the in-pixel memories according to the t1-st display sync signal t1 i-VSync.

For example, the display driver IC 200 may generate the t1-st display data as the n-bit data, to thereby (i) update each of the in-pixel memories to the t1-st display data as the n-bit data, (ii) instruct the display panel having in-pixel memory 300 to convert the n-bit data into the PWM signal, and (iii) drive each of the light-emitting elements corresponding to each of the pixels by using the PWM signal.

Considering the above, in order to drive at low power, after the t1-st frame when the still image is displayed, the host 100 may transmit the command mode switching signal. For example, in order to drive in the low power for the still image, the host 100 may not transmit next video data after transmitting the command mode switching signal to the display driver IC 200, while the host 100 is transmitting the video data according to the MIPI video mode.

Accordingly, the display driver IC 200 may switch the MIPI video mode into a MIPI command mode. In detail, while not transmitting the interrupt signal, for example, a TE (i.e., Tearing Effect) signal, which is for requesting transmission of the video data to the host 100 in a conventional MIPI command mode, the display driver IC 200 may generate a t11-th display sync signal t11 i-VSync corresponding to a pre-set condition based on an internal clock, and transmit the t11-th display sync signal to the display panel having in-pixel memory 300, to thereby instruct the display panel having in-pixel memory 300 to display the t1-st video image corresponding to the t1-st display data stored in the in-pixel memories according to the t11-th display sync signal t11 i-VSync, and thus display the still image.

Herein, a frequency of the t11-th display sync signal t11 i-VSync may be same as a frequency of the t1-st display sync signal t1 i-VSync, but preferably, they may be of different frequencies. For example, the frequency of the t1-st display sync signal t1 i-VSync may be 120 Hz, while the frequency of the t11-th display sync signal t11 i-VSync may be 1 Hz.

Therefore, for the still image, unlike conventional methods where the host 100 has to continuously transmit still image data, the host 100 may drive in the low power by transmitting the command mode switching signal and then stop transmitting additional still image data. Further, unlike the conventional command mode where the TE signal for requesting transmission of the video data is required to be transmitted, the display driver IC 200, in response to switching to the command mode, may not be required to transmit the TE signal for requesting transmission of the video data to the host 100, thereby allowing the display driver IC 200 to be driven in the low power.

While displaying the still image by the method as explained above, in order to replay the video, i.e., in order to terminate the ECO mode, the host 100 may transmit a video mode switching signal. That is the host 100 may request to switch from the MIPI command mode for the still image to the MIPI video mode for displaying the video.

Then, the display driver IC 200, in response to the video mode switching signal, may block the t1-st video image from being displayed through the display panel having in-pixel memory 300. That is, by allowing the display driver IC 200 not to transmit the t11-th display sync signal, the display panel having in-pixel memory 300 may block the light-emitting elements, which are driven by PWM, from displaying the gradation, thereby not displaying the video.

Afterwards, in response to receiving, from the host 100 after the video mode switching signal, the t2-nd MIPI sync signal corresponding to the t2-nd frame and the t2-nd video data corresponding to the t2-nd frame, wherein the t2-nd video data is in sync with the t2-nd MIPI sync signal, the display driver IC 200 may (i) synchronize the t2-nd MIPI sync signal (i.e., t2 MIPI VSync, t2 MIPI HSync) with a t2-nd display sync signal t2 i-VSync, (ii) generate a t2-nd display data corresponding to the t2-nd frame by referring to the t2-nd video data t2 DATA, and (iii) transmit the t2-nd display sync signal t2 i-VSync and the t2-nd display data to the display panel having in-pixel memory 300, to thereby store the t2-nd display data in the in-pixel memories of the display panel having in-pixel memory 300. Herein, the t1-st display data stored in the in-pixel memories may be updated to the t2-nd display data.

Herein, the display driver IC 200 may not display the video on the display panel having in-pixel memory 300 by turning off a PWM driving of the display panel having in-pixel memory during a time range of from a time of the display driver IC 200 receiving the video mode switching signal from the host 100 to a time of displaying the t2-nd display data corresponding to the t2-nd video data, which was received from the host 100. Herein, the time range of not displaying the video on the display panel having in-pixel memory 300 may correspond to a time range of at most one frame depending on when the video mode switching signal is received during a region of the t11-th display sync signal that is currently driving the display panel having in-pixel memory 300. That is, if it is assumed that a video image corresponding to the t2-nd frame is to be displayed on the display panel having in-pixel memory 300 immediately after the video mode switching signal is received from the host 100, and without a synchronization of the display sync signal with the MIPI sync signal of the host 100, the t1-st video data currently being displayed and the t2-nd video data may be mixed together, which may deteriorate a display quality. Therefore, during a region of the display sync signal right after receiving the video mode switching signal, the display panel having in-pixel memory 300 is set not to display the video image, thereby preventing the video image from being mixed.

For example, the display driver IC 200 may receive a t2-nd MIPI vertical sync signal t2 MIPI VSync from the host 100, and sequentially receive, from the host 100, a pair of a (t2_1)-st MIPI horizontal sync signal t2_1 MIPI HSync and a (t2_1)-st horizontal video data t2_1 DATA to a pair of a (t2_p)-th MIPI horizontal sync signal t2_p MIPI HSync and a (t2_p)-th horizontal video data t2_p DATA, each of which corresponds to each of the p display lines in the display panel having in-pixel memory 300. Herein the (t2_1)-st horizontal video data t2_1 DATA may be in sync with the (t2_1)-st MIPI horizontal sync signal t2_1 MIPI HSync and the (t2_p)-th horizontal video data t2_p DATA may be in sync with the (t2_p)-th MIPI horizontal sync signal t2_p MIPI HSync.

Further, the display driver IC 200, at a time of receiving a (t2_k)-th MIPI horizontal sync signal t2_k MIPI HSync and a (t2_k)-th horizontal video data t2_k DATA from the host 100, may (1) synchronize the (t2_k)-th MIPI horizontal sync signal t2_k MIPI HSync with a (t2_k)-th horizontal display sync signal t2_k i-HSync, (2) generate a (t2_k)-th horizontal display data by referring to the (t2_k)-th horizontal video data t2_k DATA, and (3) transmit the (t2_k)-th horizontal display sync signal t2_k i-HSync and the (t2_k)-th horizontal display data to the display panel having in-pixel memory 300, to thereby update the (t1_k)-th horizontal display data stored in the in-pixel memories, which are included within the k-th display line, to the (t2_k)-th horizontal display data. Herein k is an integer greater than or equal to 1 and less than or equal to p.

Herein, the display driver IC 200 may transmit the (t2_k)-th horizontal display data in parallel to the display panel having in-pixel memory 300 by using the shift register or the line buffer, to thereby allow the (t2_k)-th horizontal display data to be simultaneously stored in the in-pixel memories, which are included within the k-th display line.

Then, the display panel having in-pixel memory 300 may display a t2-nd video image corresponding to the t2-nd display data stored in the in-pixel memories according to the t2-nd display sync signal t2 i-VSync.

For example, the display driver IC 200 may generate the t2-nd display data as the n bit data, to thereby (i) update each of the in-pixel memories to the t2-nd display data, which is the n bit data, (ii) instruct the display panel having in-pixel memory 300 to convert the n-bit data into the PWM signal, and (iii) drive each of the light-emitting elements corresponding to each of the pixels by using the PWM signal.

The present disclosure has an effect of driving a display system including the display panel having in-pixel memory at low power with the MIPI (i.e., Mobile Industry Processor Interface).

The present disclosure has another effect of minimizing the number of transmission of video data from the host with the MIPI thereby reducing a burden of the host and minimizing a power consumption of the host.

The present disclosure has still another effect of minimizing the number of refreshing the video data of the display driver IC and minimize a power consumption of the display driver IC.

The present disclosure has still yet another effect of allowing the display driver IC to display the still image by using data stored in the in-pixel memories according to a MIPI sync signal while the host transmits only the MIPI sync, thereby minimizing power consumptions of the host and the display driver IC.

The present disclosure has still yet another effect of displaying the still image by using the data stored in the in-pixel memories while disabling the MIPI, thereby minimizing power consumptions of the host and the display driver IC.

The present disclosure has still yet another effect of displaying the still image by using the data stored in the in-pixel memories while being switched to a command mode, thereby minimizing the power consumptions of the host and the display driver IC.

The embodiments of the present disclosure as explained above can be implemented in a form of executable program command through a variety of computer means recordable in computer readable media. The computer readable media may include solely or in combination, program commands, data files, and data structures. The program commands recorded to the media may be components specially designed for the present disclosure or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands may include not only a machine language code made by a complier but also a high-level code that can be used by an interpreter etc., which is executed by a computer. The aforementioned hardware device can work as more than a software module to perform the action of the present disclosure and they can do the same in the opposite case.

As seen above, the present disclosure has been explained by specific matters such as detailed components, limited embodiments, and drawings. They have been provided only to help more general understanding of the present disclosure. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for driving a display system with a MIPI (Mobile Industry Processor Interface), comprising steps of:
(a) upon receiving, from a host, a t1-st MIPI sync signal corresponding to a t1-st frame and a t1-st video data corresponding to the t1-st frame, wherein the t1-st video data is in sync with the t1-st MIPI sync signal, a display driver IC (i) synchronizing the t1-st MIPI sync signal with a t1-st display sync signal, (ii) generating a t1-st display data corresponding to the t1-st frame by referring to the t1-st video data, and (iii) transmitting the t1-st display sync signal and the t1-st display data to a display panel having in-pixel memory, to thereby instruct the display panel having in-pixel memory to store the t1-st display data in in-pixel memories and display a t1-st video image corresponding to the t1-st display data stored in the in-pixel memories according to the t1-st display sync signal; and
(b) in response to receiving a (t1+1)-th MIPI sync signal only corresponding to a (t1+1)-th frame, the display driver IC synchronizing the (t1+1)-th MIPI sync signal with a (t1+1)-th display sync signal, and transmitting the (t1+1)-th display sync signal to the display panel having in-pixel memory, to thereby instruct the display panel having in-pixel memory to display the t1-st video image corresponding to the t1-st display data stored in the in-pixel memories according to the (t1+1)-th display sync signal.

2. The method of claim 1, further comprising a step of:
(c) upon receiving, from the host, a t2-nd MIPI sync signal corresponding to a t2-nd frame and a t2-nd video data corresponding to the t2-nd frame, wherein the t2-nd frame is apart from the (t1+1)-th frame by at least one frame, and wherein the t2-nd video data is in sync with the t2-nd MIPI sync signal, the display driver IC synchronizing the t2-nd MIPI sync signal with a t2-nd display sync signal, generating a t2-nd display data corresponding to the t2-nd frame from the t2-nd video data, and transmitting the t2-nd display sync signal and the t2-nd display data to the display panel having in-pixel memory, to thereby instruct the display panel having in-pixel memory to update the t1-st display data stored in the in-pixel memories to the t2-nd display data, and display a t2-nd video image corresponding to the t2-nd display data updated in the in-pixel memories according to the t2-nd display sync signal.

3. The method of claim 2, wherein, at the step of (c), the display driver IC (i) receives, from the host, a t2-nd MIPI vertical sync signal, and sequentially receives, from the host, a pair of a (t2_1)-st MIPI horizontal sync signal and a (t2_1)-st horizontal video data to a pair of a (t2_p)-th MIPI horizontal sync signal and a (t2_p)-th horizontal video data, each corresponding to each of p display lines in the display panel having in-pixel memory, wherein p is an integer greater than or equal to 1, and wherein the (t2_1)-st horizontal video data is in sync with the (t2_1)-st MIPI horizontal sync signal and the (t2_p)-th horizontal video data is in sync with the (t2_p)-th MIPI horizontal sync signal, and (ii) at a time of receiving a (t2_k)-th MIPI horizontal sync signal and a (t2_k)-th horizontal video data from the host, wherein k is an integer greater than or equal to 1 and less than or equal to p, (ii-1) synchronizes the (t2_k)-th MIPI horizontal sync signal with a (t2_k)-th display horizontal sync signal, (ii-2) generates a (t2_k)-th horizontal display data by referring to the (t2_k)-th horizontal video data, and (ii-3) transmits the (t2_k)-th horizontal display sync signal and the (t2_k)-th horizontal display data to the display panel having in-pixel memory, to thereby instruct the display panel having in-pixel memory to update the (t2_k)-th horizontal display data in the in-pixel memories, which are included in the k-th display line.

4. The method of claim 3, wherein, at the step of (c), the display driver IC transmits the (t2_k)-th horizontal display data in parallel to the display panel having in-pixel memory by using a shift register or a line buffer, to thereby instruct the display panel having in-pixel memory to simultaneously store the (t2_k)-th horizontal display data in the in-pixel memories which are included within the k-th display line.

5. The method of claim 2, wherein, at the step of (c), the display driver IC generates the t2-nd display data as n bit data, wherein n is an integer greater than or equal to 2, to thereby (i) update each of the in-pixel memories to the t2-nd display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

6. The method of claim 1, wherein, at the step of (a), the display driver IC receives, from the host, a t1-st MIPI vertical sync signal, and sequentially receives, from the host, a pair of a (t1_1)-st MIPI horizontal sync signal and a (t1_1)-st horizontal video data to a pair of a (t1_p)-th MIPI horizontal sync signal and a (t1_p)-th horizontal video data, each of which corresponds to each of p display lines in the display panel having in-pixel memory, wherein the (t1_1)-st horizontal video data is in sync with the (t1_1)-st MIPI horizontal sync signal and the (t1_p)-th horizontal video data is in sync with the (t1_p)-th MIPI horizontal sync signal, and (ii) at a time of receiving a (t1_k)-th MIPI horizontal sync signal and a (t1_k)-th horizontal video data from the host, wherein k is an integer greater than or equal to 1 and less than or equal to p, (ii-1) synchronizes the (t1_k)-th MIPI horizontal sync signal with a (t1_k)-th horizontal display sync signal, (ii-2) generates a (t1_k)-th horizontal display data by referring to the (t1_k)-th horizontal video data, and (ii-3) transmits the (t1_k)-th horizontal display sync signal and the (t1_k)-th horizontal display data to the display panel having in-pixel memory, to thereby instruct the display panel having in-pixel memory to update the in-pixel memories, which are included within the k-th display line, to the (t1_k)-th horizontal display data.

7. The method of claim 6, wherein, at the step of (a), the display driver IC transmits the (t1_k)-th horizontal display data in parallel to the display panel having in-pixel memory by using a shift register or a line buffer, to thereby instruct the display panel having in-pixel memory to simultaneously store the (t1_k)-th horizontal display data in the in-pixel memories, which are included within the k-th display line.

8. The method of claim 1, wherein, at the step of (a), the display driver IC generates the t1-st display data as an n bit data, wherein n is an integer greater than or equal to 2, to thereby (i) update each of the in-pixel memories to the t1-st display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

9. A display device for driving a display system with a MIPI (Mobile Industry Processor Interface), comprising:
a display driver IC; and
a display panel having in-pixel memory;
(I) wherein, upon receiving, from a host, a t1-st MIPI sync signal corresponding to a t1-st frame and a t1-st video data corresponding to the t1-st frame, the t1-st video data being in sync with the t1-st MIPI sync signal, the display driver IC (i) synchronizes the t1-st MIPI sync signal with a t1-st display sync signal, (ii) generates a t1-st display data corresponding to the t1-st frame by referring to the t1-st video data, and (iii) transmits the t1-st display sync signal and the t1-st display data to the display panel having in-pixel memory, to thereby instruct the display panel having in-pixel memory to store the t1-st display data in in-pixel memories and display a t1-st video image corresponding to the t1-st display data stored in the in-pixel memories according to the t1-st display sync signal; and
(II) wherein, on condition that the display driver IC has received a (t1+1)-th MIPI sync signal only corresponding to a (t1+1)-th frame, the display driver IC synchronizes the (t1+1)-th MIPI sync signal with a (t1+1)-th display sync signal, and transmits the (t1+1)-th display sync signal to the display panel having in-pixel memory, to thereby instruct the display panel having in-pixel memory to display the t1-st video image corresponding to the t1-st display data stored in the in-pixel memories according to the (t1+1)-th display sync signal.

10. The display device of claim 9, wherein, (III) upon receiving, from the host, a t2-nd MIPI sync signal corresponding to a t2-nd frame and t2-nd video data corresponding to the t2-nd frame, the t2-nd video data being in sync with the t2-nd MIPI sync signal and the t2-nd frame being apart from the (t1+1)-th frame by at least one frame, the display driver IC synchronizes the t2-nd MIPI sync signal with a t2-nd display sync signal, generates t2-nd display data corresponding to the t2-nd frame from the t2-nd video data, and transmits the t2-nd display sync signal and the t2-nd display data to the display panel having in-pixel memory, to thereby instruct the display panel having in-pixel memory to update the t1-st display data stored in the in-pixel memories to the t2-nd display data, and display a t2-nd video image corresponding to the t2-nd display data updated in the in-pixel memories according to the t2-nd display sync signal.

11. The display device of claim 10, wherein, at the (III), the display driver IC (i) receives, from the host, a t2-nd MIPI vertical sync signal, and sequentially receives, from the host, a pair of a (t2_1)-st MIPI horizontal sync signal and a (t2_1)-st horizontal video data to a pair of a (t2_p)-th MIPI horizontal sync signal and a (t2_p)-th horizontal video data, each corresponding to each of p display lines in the display panel having in-pixel memory, wherein p is an integer greater than or equal to 1, and wherein the (t2_1)-st horizontal video data is in sync with the (t2_1)-st MIPI horizontal sync signal and the (t2_p)-th horizontal video data is in sync with the (t2_p)-th MIPI horizontal sync signal, and (ii) at a time of receiving a (t2_k)-th MIPI horizontal sync signal and a (t2_k)-th horizontal video data from the host, wherein k is an integer greater than or equal to 1 and less than or equal to p, (ii-1) synchronizes the (t2_k)-th MIPI horizontal sync signal with a (t2_k)-th display horizontal sync signal, (ii-2) generates a (t2_k)-th horizontal display data by referring to the (t2_k)-th horizontal video data, and (ii-3) transmits the (t2_k)-th horizontal display sync signal and the (t2_k)-th horizontal display data to the display panel having in-pixel memory, to thereby instruct the display panel having in-pixel memory to update the (t2_k)-th horizontal display data in the in-pixel memories, which are included in the k-th display line.

12. The display driver of claim 11, wherein, at the (III), the display driver IC transmits the (t2_k)-th horizontal display data in parallel to the display panel having in-pixel memory by using a shift register or a line buffer, to thereby instruct the display panel having in-pixel memory to simultaneously store the (t2_k)-th horizontal display data in the in-pixel memories which are included within the k-th display line.

13. The display driver of claim 10, wherein, at the (III), the display driver IC generates the t2-nd display data as n bit data, wherein n is an integer greater than or equal to 2, to thereby (i) update each of the in-pixel memories to the t2-nd display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.

14. The display driver of claim 9, wherein, at the (I), the display driver IC receives, from the host, a t1-st MIPI vertical sync signal, and sequentially receives, from the host, a pair of a (t1_1)-st MIPI horizontal sync signal and a (t1_1)-st horizontal video data to a pair of a (t1_p)-th MIPI horizontal sync signal and a (t1_p)-th horizontal video data, each of which corresponds to each of p display lines in the display panel having in-pixel memory, wherein the (t1_1)-st horizontal video data is in sync with the (t1_1)-st MIPI horizontal sync signal and the (t1_p)-th horizontal video data is in sync with the (t1_p)-th MIPI horizontal sync signal, and (ii) at a time of receiving a (t1_k)-th MIPI horizontal sync signal and a (t1_k)-th horizontal video data from the host, wherein k is an integer greater than or equal to 1 and less than or equal to p, (ii-1) synchronizes the (t1_k)-th MIPI horizontal sync signal with a (t1_k)-th horizontal display sync signal, (ii-2) generates a (t1_k)-th horizontal display data by referring to the (t1_k)-th horizontal video data, and (ii-3) transmits the (t1_k)-th horizontal display sync signal and the (t1_k)-th horizontal display data to the display panel having in-pixel memory, to thereby instruct the display panel having in-pixel memory to update the in-pixel memories, which are included within the k-th display line, to the (t1_k)-th horizontal display data.

15. The display driver of claim 14, wherein, at the (I), the display driver IC transmits the (t1_k)-th horizontal display data in parallel to the display panel having in-pixel memory by using a shift register or a line buffer, to thereby instruct the display panel having in-pixel memory to simultaneously store the (t1_k)-th horizontal display data in the in-pixel memories, which are included within the k-th display line.

16. The display driver of claim 9, wherein, at the (I), the display driver IC generates the t1-st display data as an n bit data, wherein n is an integer greater than or equal to 2, to thereby (i) update each of the in-pixel memories to the t1-st display data, which is the n bit data, (ii) instruct the display panel having in-pixel memory to convert the n-bit data into a PWM (Pulse Width Modulation) signal, and (iii) drive each of light-emitting elements corresponding to each of pixels by using the PWM signal.
